(19) United States
(12) Patent Application Publication
(10) Pub. No.: US 2026/0303861 A1
(43) Pub. Date: Oct. 1, 2026

(54) INTRA PREDICTION-BASED IMAGE ENCODING/DECODING METHOD AND DEVICE, AND RECORDING MEDIUM STORING BITSTREAM

(71) Applicant: LG Electronics Inc., Seoul (KR)

(72) Inventors: Myungoh HONG, Seoul (KR); Nae Ri PARK, Seoul (KR); Jaehyun LIM, Seoul (KR); Sunmi YOO, Seoul (KR)

(21) Appl. No.: 19/479,161

(22) PCT Filed: Apr. 25, 2024
(86) PCT No.: PCT/KR2024/005623

§ 371 Date: Oct. 27, 2025

Related U.S. Application Data
(60) Provisional application No. 63/462,505, filed on Apr. 27, 2023.

(51) Int. Cl. H04N 19/593; H04N 19/105; H04N 19/11; H04N 19/136; H04N 19/176; H04N 19/186; H04N 19/30

(52) U.S. Cl. CPC H04N 19/593; H04N 19/105; H04N 19/11; H04N 19/136; H04N 19/176; H04N 19/186; H04N 19/30

(57) ABSTRACT

An image encoding/decoding method and apparatus are provided. The image decoding method according to the present disclosure may comprise the steps of: obtaining block vector information of a corresponding luma block corresponding to the current chroma block; identifying a chroma reference block of the current chroma block and a luma reference block of the corresponding luma block based on the block vector information; generating a prediction parameter based on the chroma reference block and the luma reference block; and generating a final chroma prediction block of the current chroma block based on the generated prediction parameter.

### TECHNICAL FIELD

The present disclosure relates to an image encoding/decoding method and apparatus and a recording medium storing a bitstream, and more particularly, to an image encoding/decoding method and apparatus based on intra prediction and a recording medium storing a bitstream generated using an image encoding method/apparatus.

### BACKGROUND

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

The present disclosure is directed to providing an image encoding/decoding method and apparatus with improved encoding/decoding efficiency.

The present disclosure is also directed to providing an image encoding/decoding method and apparatus for effectively performing intra prediction.

The present disclosure is also directed to providing an image encoding/decoding method and apparatus for effectively performing chroma prediction by utilizing block vector (BV) information.

The present disclosure is also directed to providing a non-transitory computer-readable recording medium for storing a bitstream generated using an image encoding method or apparatus in accordance with the present disclosure.

The present disclosure is also directed to providing a non-transitory computer-readable recording medium for storing a bitstream that is received and decoded by an image decoding apparatus according to the present disclosure and used for image reconstruction.

The present disclosure is also directed to providing a method of transmitting a bitstream generated using an image encoding method or apparatus according to the present disclosure.

Technical objects to be achieved in the present disclosure are not limited to those described above, and other technical objects that have not been described above will be clearly understood by those skilled in the technical field to which the present disclosure pertains from the following description.

### Technical Solution

According to an embodiment of the present disclosure, an image decoding method performed by an image decoding apparatus includes: obtaining block vector (BV) information of a corresponding luma block corresponding to a current chroma block; identifying a chroma reference block of the current chroma block and a luma reference block of the corresponding luma block based on the BV information; generating a prediction parameter based on the chroma reference block and the luma reference block; and generating a final chroma prediction block of the current chroma block based on the generated prediction parameter.

According to the embodiment of the present disclosure, based on the corresponding luma block being plural in number, the BV information may include BV information of a predetermined position within the plurality of corresponding luma blocks.

According to the embodiment of the present disclosure, the plurality of corresponding luma blocks may include a top-left corresponding luma block, a top-right corresponding luma block, a bottom-left corresponding luma block, a bottom-right corresponding luma block, and a central corresponding luma block, and the predetermined position may include at least one of a top-left luma sample position in the top-left corresponding luma block, a top-right luma sample position in the top-right corresponding luma block, a bottom-left luma sample position in the bottom-left corresponding luma block, a bottom-right luma sample position in the bottom-right corresponding luma block, and a top-left luma sample position in the central corresponding luma block.

According to the embodiment of the present disclosure, the image decoding method may further include, generating a BV candidate list based on the BV information of the predetermined position being N pieces in number and obtaining a first BV index indicating first BV information included in the BV candidate list. The final chroma prediction block may be generated based on the first BV index, and N may be a natural number.

According to the embodiment of the present disclosure, the image decoding method may further include, generating a BV candidate list based on the BV information of the predetermined position being N pieces in number, obtaining a second BV index indicating second BV information included in the BV candidate list, and obtaining a third BV index indicating third BV information included in the BV candidate list. The final chroma prediction block may be generated by calculating a weighted sum of a first chroma prediction block which is generated based on the second BV index and a second chroma prediction block which is generated based on the third BV index, and N may be a natural number.

According to the embodiment of the present disclosure, the BV information of the predetermined position for generating the BV candidate list may be searched for in a predetermined order.

According to the embodiment of the present disclosure, the generating of the prediction parameter may further include down-sampling the luma reference block based on a size of the chroma reference block.

According to the embodiment of the present disclosure, the generating of the final chroma prediction block may include generating a third chroma prediction block based on an intra prediction mode, generating a fourth chroma prediction block based on the prediction parameter, and generating a final chroma prediction block by calculating a weighted sum of the third chroma prediction block and the fourth chroma prediction block.

According to the embodiment of the present disclosure, the intra prediction mode may be one of a planar mode, a direct current (DC) mode, and directional modes.

According to the embodiment of the present disclosure, the prediction parameter may be one of a filer coefficient used in a convolutional cross-component intra prediction model (CCCM) and a linear model parameter used in a cross-component linear model (CCLM).

According to the embodiment of the present disclosure, the BV information of the corresponding luma block may include BV information of neighboring blocks of the corresponding luma block.

According to another embodiment of the present disclosure, an image encoding method performed by an image encoding apparatus includes: encoding BV information of a corresponding luma block corresponding to a current chroma block; identifying a chroma reference block of the current chroma block and a luma reference block of the corresponding luma block based on the BV information; generating a prediction parameter based on the chroma reference block and the luma reference block; and generating a final chroma prediction block of the current chroma block based on the generated prediction parameter.

According to another aspect of the present disclosure, a computer-readable recording medium stores a bitstream generated using an image encoding method.

According to another aspect of the present disclosure, a method of transmitting a bitstream generated using an image encoding method is provided, the image encoding method including: encoding BV information of a corresponding luma block corresponding to a current chroma block; identifying a chroma reference block of the current chroma block and a luma reference block of the corresponding luma block based on the BV information; generating a prediction parameter based on the chroma reference block and the luma reference block; and generating a final chroma prediction block of the current chroma block based on the generated prediction parameter.

### Advantageous Effects

According to the present disclosure, it is possible to provide an image encoding/decoding method and apparatus with improved encoding/decoding efficiency.

According to the present disclosure, it is also possible to provide an image encoding/decoding method and apparatus for effectively performing intra prediction.

According to the present disclosure, it is also possible to provide an image encoding/decoding method and apparatus for performing chroma prediction by utilizing block vector (BV) information.

According to the present disclosure, it is also possible to provide a non-transitory computer-readable recording medium for storing a bitstream generated using an image encoding method or apparatus in accordance with the present disclosure.

According to the present disclosure, it is also possible to provide a non-transitory computer-readable recording medium for storing a bitstream that is received and decoded by an image decoding apparatus in accordance with the present disclosure and used for image reconstruction.

According to the present disclosure, it is also possible to provide a method of transmitting a bitstream generated using an image encoding method or apparatus in accordance with the present disclosure.

Effects of the present disclosure are not limited to those described above, and other effects that have not been described above will be clearly understood by those skilled in the technical field to which the present disclosure pertains from the following description.

### DESCRIPTION OF DRAWINGS

FIG. 1 is a view schematically showing a video coding system, to which an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an

FIG. 4 is a flowchart illustrating a video/image encoding method based on intra prediction.

FIG. 5 is a diagram illustrating a configuration of an intra prediction unit according to the present disclosure.

FIG. 6 is a flowchart illustrating a video/image decoding method based on intra prediction.

FIG. 7 is a diagram illustrating a configuration of an intra prediction unit according to the present disclosure.

FIG. 8 is a diagram showing template areas used in a template-based intra mode derivation (TIMD) mode according to the present disclosure.

FIG. 9 is a diagram illustrating a template matching (TM)-based encoding/decoding method according to the present disclosure.

FIG. 10 is a diagram showing a block vector (BV) in an intra block copy (IBC) mode according to an embodiment of the present disclosure.

FIG. 11 is a diagram showing a reference area in an IBC mode according to an embodiment of the present disclosure.

FIG. 12 is a diagram showing positions of neighboring samples used in a multiple direct modes (MDM) mode according to an embodiment of the present disclosure.

FIG. 13 is a view showing a method of categorizing neighboring samples into two groups according to an embodiment of the present disclosure.

FIG. 14 is a diagram showing positions of neighboring samples used for deriving a cross-component linear model (CCLM) parameter according to an embodiment of the present disclosure.

FIG. 15 is a diagram showing a gradient pattern for a gradient linear model (GLM) according to an embodiment of the present disclosure.

FIG. 16 is a diagram showing a gradient pattern for the GLM according to an embodiment of the present disclosure.

FIG. 17 is a diagram showing BVs when a corresponding luma block is in the IBC mode according to an embodiment of the present disclosure.

FIG. 18 is a diagram showing a corresponding luma block according to an embodiment of the present disclosure.

FIGS. 19 and 20 are flowcharts of a method of generating a chroma prediction block according to an embodiment of the present disclosure.

FIG. 21 is a diagram showing reference blocks when multiple BVs exist according to an embodiment of the present disclosure.

FIG. 22 is a diagram showing multiple luma reference blocks and a current chroma block according to an embodiment of the present disclosure.

FIG. 23 is a flowchart of an image encoding method according to an embodiment of the present disclosure.

FIG. 24 is a flowchart of an image decoding method according to an embodiment of the present disclosure.

FIG. 25 is a view showing a content streaming system to which an embodiment of the present disclosure is applicable.

### MODES OF THE INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In this disclosure, “video” may refer to a collection of images in sequence over time.

In the present disclosure, a “picture” generally refers to a unit representing one image at a specific time, and a slice/tile is a coding unit constituting a portion of a picture, and a picture may be composed of one or more slices/tiles. In addition, a slice/tile may include one or more coding tree units (CTUs).

A “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with the terms such as “sample array”, “block” or “area” in some cases. In a general case, an M×N block may include a set (or array) of samples (or a sample array) or transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, “or” may be interpreted as “and/or.” For example, “A or B” may mean 1) only “A,” 2) only “B,” or 3) “A and B.” Alternatively, in the present disclosure, “or” may mean “additionally or alternatively.”

In the present disclosure, “at least one of A, B, and C” may mean “only A,” “only B,” “only C,” or “any combination of A, B, and C.” Also, “at least one of A, B, or C” or “at least one of A, B, and/or C” may mean “at least one of A, B, and C.”

Parentheses used in the present disclosure may mean “for instance.” For example, when there is the phrase “prediction (intra prediction),” “intra prediction” may have been proposed as an example of “prediction.” In other words, “prediction” in the present disclosure may not be limited to “intra prediction,” and “intra prediction” may have been proposed as an example of “prediction.” In addition, when there is the phrase “prediction (i.e., intra prediction),” “intra prediction” may have been proposed as an example of “prediction.”

### Overview of Video Coding System

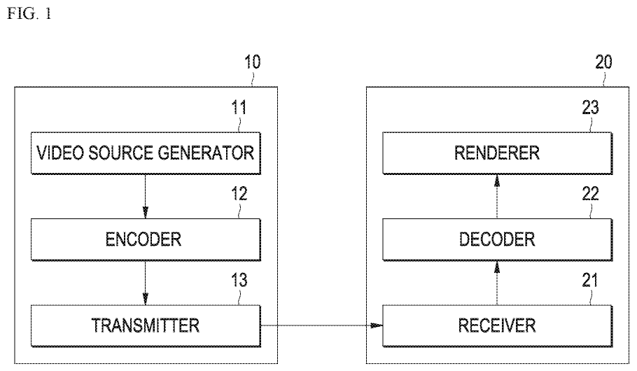

FIG. 1 is a view showing a video coding system to which an embodiment of the present disclosure is applicable.

The video coding system according to an embodiment may include an encoding device 10 and a decoding device 20. The encoding device 10 may deliver encoded video and/or image information or data to the decoding device 20 in the form of a file or streaming via a digital storage medium or network.

The encoding device 10 according to an embodiment may include a video source generator 11, an encoding unit (encoder) 12 and a transmitter 13. The decoding device 20 according to an embodiment may include a receiver 21, a decoding unit (decoder) 22 and a renderer 23. The encoding unit 12 may be called a video/image encoding apparatus, and the decoding unit 22 may be called a video/image decoding apparatus. The transmitter 13 may be included in the encoding unit 12. The receiver 21 may be included in the decoding unit 22. The renderer 23 may include a display and the display may be configured as a separate device or an external component.

The video source generator 11 may obtain a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may obtain the encoded video/image information or data output in the form of a bitstream and forward it to the receiver 21 of the decoding apparatus 20 or another external object through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The transmitter 13 may be provided as a transmission device separate from the encoding apparatus 12, and in this case, the transmission device may include at least one processor that obtains encoded video/image information or data output in the form of a bitstream and a transmission unit for transmitting it in the form of a file or streaming. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

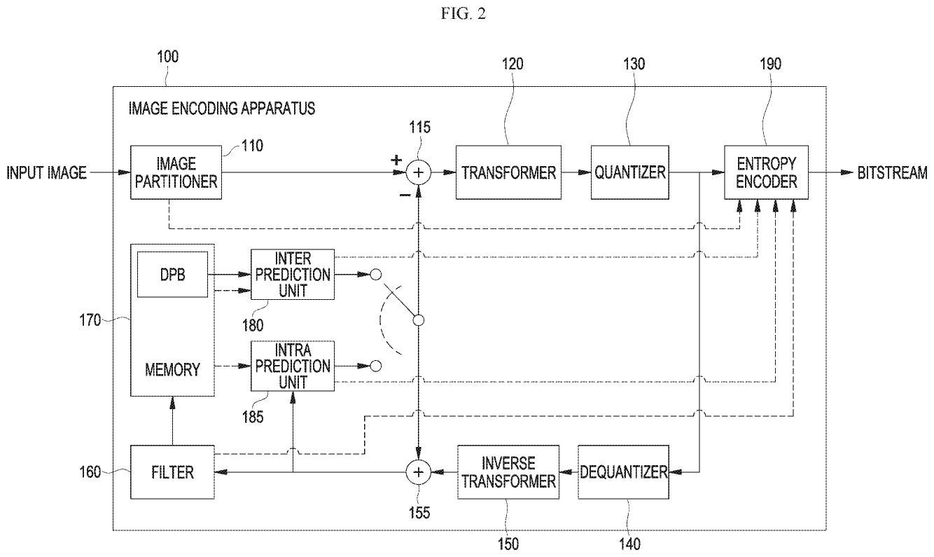

FIG. 2 is a view schematically showing an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be obtained by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth obtained by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform obtained based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

Meanwhile, LMCS (luma mapping with chroma scaling) may be applied during the picture encoding and/or restoration process.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

### Overview of Image Decoding Apparatus

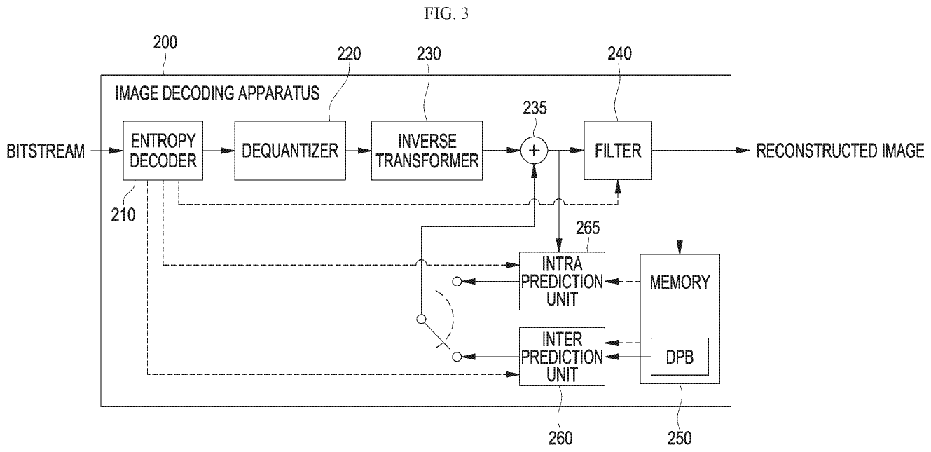

FIG. 3 is a view schematically showing an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 170 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be obtained by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

### Overview of Intra Prediction

Intra prediction according to the present disclosure will be described below.

Intra prediction may refer to prediction of generating prediction samples of a current block based on reference samples within a picture to which the current block belongs (hereinafter, “current picture”). When intra prediction is applied to the current block, neighboring reference samples to be used for intra prediction of the current block may be derived. The neighboring reference samples of the current block may include a total of 2×nH samples that are adjacent to a left boundary of the current block with a size of nW×nH or neighbor on a bottom-left side, a total of 2×nW samples that are adjacent to a top boundary of the current block or neighbor on a top-right side, and one sample neighboring on a top-left side of the current block. Alternatively, neighboring reference samples of the current block may include top neighboring samples of a plurality of columns and left neighboring samples of a plurality of rows. In addition, the neighboring reference samples of the current block may include a total of nH samples adjacent to a right boundary of the current block with a size of nW×nH, a total of nW samples adjacent to a bottom boundary of the current block, and one sample neighboring a bottom-right side of the current block.

However, some of the neighboring reference samples of the current block may not have been decoded yet or may be unusable. In this case, a decoder may construct neighboring reference samples which will be used for prediction by substituting the unusable samples with usable samples. Alternatively, the decoder may construct neighboring reference samples which will be used for prediction through interpolation of usable samples.

When neighboring reference samples are derived, (i) a prediction sample may be derived based on an average of the neighboring reference samples of the current block or interpolation based on the neighboring reference samples, or (ii) the prediction sample may be derived based on a reference sample that exists in a specific (prediction) direction from a prediction sample among the neighboring reference samples of the current block. The case of (i) may be referred to as a non-directional mode or non-angular mode, and the case of (ii) may be referred to as a directional mode or an angular mode.

Also, the prediction sample may be generated through interpolation between a first neighboring sample located in a prediction direction of an intra prediction mode of the current block based on a prediction-target sample of the current block and a second neighboring sample located in the opposite direction thereto among the neighboring reference samples. The above case may be referred to as linear interpolation intra prediction (LIP).

Also, chroma prediction samples may be generated based on luma samples using a linear model (LM). This case may be referred to as LM mode.

Also, a temporary prediction sample of the current block may be derived based on filtered neighboring reference samples, and a weighted sum of the existing neighboring reference samples, that is, at least one reference sample derived in accordance with the intra prediction mode among unfiltered neighboring reference samples and the temporary prediction sample, may be calculated to derive a prediction sample of the current block. This case may be referred to as position dependent intra prediction (PDPC).

Also, a reference sample line with the highest prediction accuracy may be selected from multiple reference sample lines neighboring on the current block, and a reference sample which exists in a prediction direction from the selected reference sample line may be used to derive a prediction sample. Here, information on the used reference sample line (e.g., intra_luma_ref_idx) may be encoded in a bitstream and signaled. This case may be referred to as multi-reference line intra prediction (MRL) or MRL-based intra prediction. When MRL is not applied, reference samples may be derived from a reference sample line directly adjacent to the current block, and in this case, information on the reference sample line may not be signaled.

Also, the current block may be divided into vertical or horizontal sub-partitions, and intra prediction may be performed on each sub-partition based on the same intra prediction mode. Here, neighboring reference samples of intra prediction may be derived for each of the sub-partitions. In other words, a reconstructed sample of a previous sub-partition in terms of an encoding/decoding sequence may be used as a neighboring reference sample of a current sub-partition. In this case, an intra prediction mode of the current block may be uniformly applied to the sub-partitions, and neighboring reference samples may be derived and used for each of the sub-partitions such that intra prediction performance can be improved in some cases. This prediction method may be referred to as intra sub-partition (ISP) or ISP-based intra prediction.

The above-described intra prediction methods may be referred to as intra prediction types, additive intra prediction modes, etc., distinguishably from directional or non-directional intra prediction modes. For example, the intra prediction techniques (intra prediction types, additive intra prediction modes, etc.) may include at least one of the above-described LIP, LM, PDPC, MRL, and ISP. General intra prediction methods other than the specific intra prediction types such as LIP, LM, PDPC, MRL, ISP may be referred to as normal intra prediction types. The normal intra prediction types may be generally applied when those specific intra prediction types are not applied, and prediction may be performed based on the foregoing intra prediction modes. Meanwhile, post-filtering may be performed on derived prediction samples as necessary.

Specifically, an intra prediction procedure may include an intra prediction mode/type determination operation, a neighboring reference sample derivation operation, and an intra prediction mode/type-based prediction sample derivation operation. In addition, a post-filtering operation may be performed on derived prediction samples as necessary.

Meanwhile, in addition to the above-described intra prediction types, affine linear weighted intra prediction (ALWIP) may be used. ALWIP may also be referred to as linear weighted intra prediction (LWIP), matrix-weighted intra prediction (MIP), or matrix-based intra prediction (MIP). When MIP is applied to the current block, i) neighboring reference samples on which an averaging procedure has been performed may be used ii) to perform a matrix-vector-multiplication procedure, and iii) a horizontal/vertical interpolation procedure may be further performed as necessary to derive prediction samples of the current block. Intra prediction modes used for MIP may be different from intra prediction modes used in the above-described LIP, PDPC, MRL, and ISP intra prediction or intra prediction modes used in normal intra prediction. Intra prediction modes for MIP may be referred to as MIP intra prediction modes, MIP prediction modes, or MIP modes. For example, a matrix and offset used in the matrix-vector-multiplication may be set differently in accordance with an intra prediction mode for MIP. Here, the matrix may be referred to as an MIP weight matrix, and the offset may be referred to as an MIP offset vector or an MIP bias vector. A detailed MIP method will be described below.

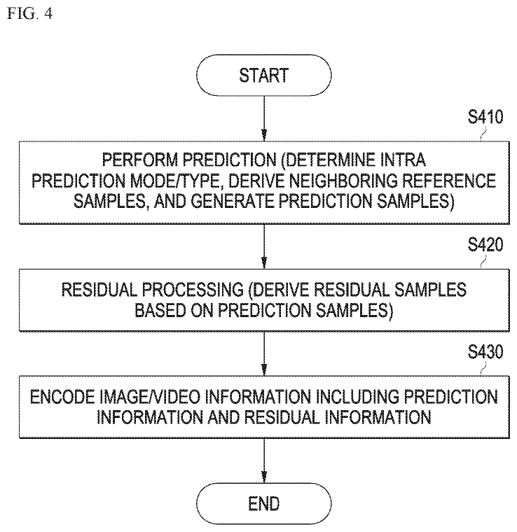

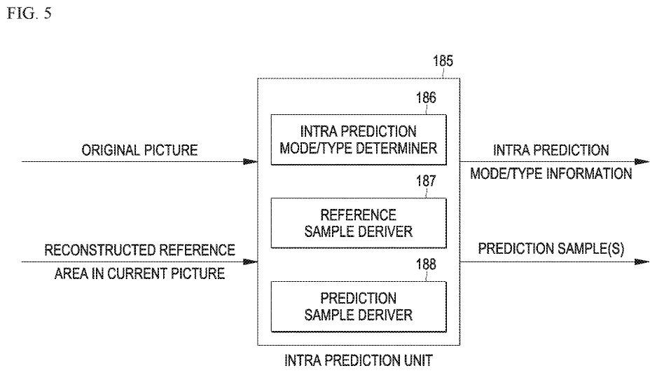

A block reconstruction procedure based on intra prediction and an intra prediction unit in an encoding apparatus will be described below with reference to FIGS. 4 and 5.

FIG. 4 is a flowchart illustrating a video/image encoding method based on intra prediction.

The encoding method of FIG. 4 may be performed by the image encoding apparatus of FIG. 2. Specifically, S410 may be performed by the intra prediction unit 185, and S420 may be performed by the residual processor. Specifically, S420 may be performed by the subtractor 115. Operation S430 may be performed by the entropy encoder 190. In operation S430, prediction information may be derived by the intra prediction unit 185, and in operation S420, residual information may be derived by the residual processor. The residual information is information on the residual samples. The residual information may include information on quantized transform coefficients for the residual samples. As described above, the residual samples may be derived as transform coefficients through the transformer 120 of the image encoding apparatus, and the transform coefficients may be derived as quantized transform coefficients through the quantizer 130. Information of the quantized transform coefficients may be encoded by the entropy encoder 190 through a residual coding procedure.

The image encoding apparatus perform intra prediction on a current block (S410). The image encoding apparatus may determine an intra prediction mode/type for the current block, derive neighboring reference samples of the current block, and generate prediction samples within the current block based on the intra prediction mode/type and the neighboring reference samples. Here, the intra prediction mode/type determination procedure, the neighboring reference sample derivation procedure, and the prediction sample generation procedure may be performed simultaneously, or any one procedure may be performed before other procedures.

FIG. 5 is a diagram illustrating a configuration of the intra prediction unit 185 according to the present disclosure.

As shown in FIG. 5, the intra prediction unit 185 of the image encoding apparatus may include an intra prediction mode/type determiner 186, a reference sample deriver 187, and a prediction sample deriver 188. The intra prediction mode/type determiner 186 may determine an intra prediction mode/type for the current block. The reference sample deriver 187 may derive neighboring reference samples of the current block. The prediction sample deriver 188 may derive prediction samples of the current block. Meanwhile, although not shown in the drawing, when a prediction sample filtering procedure which will be described below is performed, the intra prediction unit 185 may further include a prediction sample filter (not shown).

The image encoding apparatus may determine a mode/type that is applied to the current block among a plurality of intra prediction modes/types. The image encoding apparatus may compare rate-distortion (RD) costs of the intra prediction modes/types with each other and determine an optimal intra prediction mode/type for the current block.

Meanwhile, the image encoding apparatus may perform a prediction sample filtering procedure. Prediction sample filtering may be referred to as post filtering. Some or all of the prediction samples may be filtered through the prediction sample filtering procedure. In some cases, the prediction sample filtering procedure may be omitted.

Referring back to FIG. 4, the image encoding apparatus may generate residual samples for the current block based on the prediction samples or filtered prediction samples (S420). The image encoding apparatus may derive the residual samples by subtracting the prediction samples from original samples of the current block. In other words, the image encoding apparatus may derive the residual samples by subtracting the corresponding prediction samples from the original samples.

The image encoding apparatus may encode image information including information on the intra prediction (prediction information) and residual information of the residual samples (S430). The prediction information may include the intra prediction mode information and/or the intra prediction technique information. The image encoding apparatus may output the encoded image information in the form of a bitstream. The output bitstream may be forwarded to the image decoding apparatus via a storage medium or a network.

The residual information may include residual coding syntax which will be described below. The image encoding apparatus may derive quantized transform coefficients by transforming/quantizing the residual samples. The residual information may include information on the quantized transform coefficients.

Meanwhile, as described above, the image encoding apparatus may generate a reconstructed picture (including reconstructed samples and a reconstructed block). To this end, the image encoding apparatus may derive (modified) residual samples by dequantizing/inversely transforming the quantized transform coefficients. The reason for transforming/quantizing residual samples and then performing dequantization/inverse transform is to derive residual samples identical to those derived by the image decoding apparatus. The image encoding apparatus may generate a reconstructed block including reconstructed samples for the current block based on the prediction samples and the (modified) residual samples. A reconstructed picture for the current picture may be generated based on the reconstructed block. As described above, an in-loop filtering procedure, etc., may be further applied to the reconstructed picture.

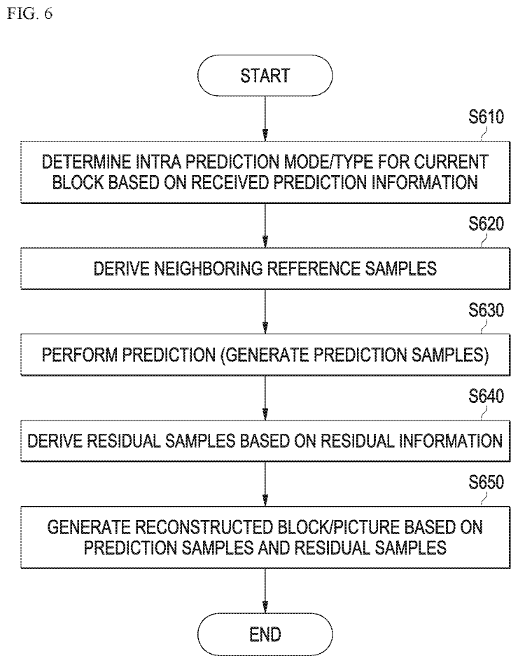

FIG. 6 is a flowchart illustrating a video/image decoding method based on intra prediction.

The image decoding apparatus may perform operations corresponding to the operations performed by the image encoding apparatus.

The decoding method of FIG. 6 may be performed by the image decoding apparatus of FIG. 3. Operations S610 to S630 may be performed by the intra prediction unit 265, and prediction information of S610 and residual information of S640 may be obtained from a bitstream by the entropy decoder 210. The residual processor of the image decoding apparatus may derive residual samples for the current block based on the residual information (S640). Specifically, the dequantizer 220 of the residual processor may derive transform coefficients by performing dequantization based on quantized transform coefficients derived from the residual information, and the inverse transformer 230 of the residual processor may derive residual samples for the current block by performing an inverse transform on the transform coefficients. Operation S650 may be performed by the adder 235 or the reconstructor.

Specifically, the image decoding apparatus may derive an intra prediction mode/type for the current block based on received prediction information (intra prediction mode/type information) (S610). Also, the image decoding apparatus may derive neighboring reference samples of the current block (S620). The image decoding apparatus may generate prediction samples within the current block based on the intra prediction mode/type and the neighboring reference samples (S630). In this case, the image decoding apparatus may perform a prediction sample filtering procedure. Prediction sample filtering may be referred to as post filtering. Some or all of the prediction samples may be filtered through the prediction sample filtering procedure. In some cases, the prediction sample filtering procedure may be omitted.

The image decoding apparatus may generate residual samples for the current block based on the received residual information (S640). The image decoding apparatus may generate reconstructed samples for the current block based on the prediction samples and the residual samples and derive a reconstructed block including the reconstructed samples (S650). A reconstructed picture for the current picture may be generated based on the reconstructed block. As described above, an in-loop filtering procedure, etc., may be further applied to the reconstructed picture.

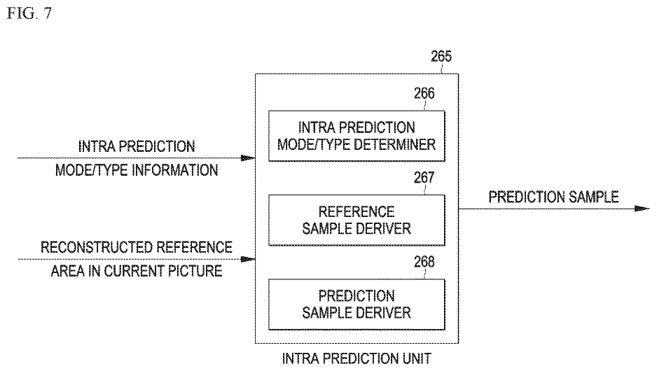

FIG. 7 is a diagram illustrating a configuration of the intra prediction unit 265 according to the present disclosure.

As shown in FIG. 7, the intra prediction unit 265 of the image decoding apparatus may include an intra prediction mode/type determiner 266, a reference sample deriver 267, and a prediction sample deriver 268. The intra prediction mode/type determiner 266 may determine an intra prediction mode/type for the current block based on the intra prediction mode/type information generated and signaled by the intra prediction mode/type determiner 186 of the image encoding apparatus, and the reference sample deriver 266 may derive the neighboring reference samples of the current block from a reconstructed reference block in a current picture. The prediction sample deriver 268 may derive the prediction samples of the current block. Meanwhile, although not shown in the drawing, when the above-described prediction sample filtering procedure is performed, the intra prediction unit 265 may further include a prediction sample filter (not shown).

The intra prediction mode information may include flag information (e.g., intra_luma_mpm_flag) indicating, for example, whether a most probable mode (MPM) or a remaining mode is applied to the current block. When the MPM is applied to the current block, the intra prediction mode information may further include index information (e.g., intra_luma_mpm_idx) indicating one of the intra prediction mode candidates (MPM candidates). The intra prediction mode candidates (MPM candidates) may constitute an MPM candidate list or an MPM list. When the MPM is not applied to the current block, the intra prediction mode information may further include remaining mode information (e.g., intra_luma_mpm_remainder) indicating one of intra prediction modes other than the intra prediction mode candidates (the MPM candidates). The image decoding apparatus may determine an intra prediction mode of the current block based on the intra prediction mode information.

In addition, the intra prediction technique information may be generated in various forms. As an example, the intra prediction technique information may include intra prediction technique index information indicating one of the intra prediction types. As another example, the intra prediction technique information may include at least one of reference sample line information (e.g., intra_luma_ref_idx) indicating whether MRL is applied to the current block and which reference sample line is used when MRL is applied when MRL is applied, ISP flag information (e.g., intra_subpartitions_mode_flag) indicating whether ISP is applied to the current block, ISP type information (e.g., intra_subparititions_split_flag) indicating partition types of sub-partitions when ISP is applied, and flag information indicating whether PDPC is applied or flag information indicating whether LIP is applied. In addition, the intra prediction type information may include an MIP flag indicating whether MIP is applied to the current block. In the present disclosure, ISP flag information may be referred to as “ISP application indicator.”

The intra prediction mode information and/or the intra prediction technique information may be encoded/decoded using a coding method described in the present document. For example, the intra prediction mode information and/or the intra prediction technique information may be encoded/decoded through entropy coding (e.g., context-adaptive binary arithmetic coding (CABAC) or context-adaptive variable-length coding (CAVLC)) based on truncated (rice) binary code.

Meanwhile, the intra prediction modes may further include cross-component linear model (CCLM) modes for chroma samples in addition to a planar mode, a direct current (DC) mode, and directional intra prediction modes. The CCLM modes may be classified as L_CCLM, T_CCLM, and LT_CCLM depending on whether left samples, top samples, or both samples are taken into consideration to derive a CCLM parameter, and may be applied to only chroma components.

For example, the intra prediction modes may be indexed as shown in table 1 below.

TABLE 1

| Intra prediction mode | Associated name |
|---|---|
| 0 | INTRA_PLANAR |
| 1 | INTRA_DC |
| 2 . . . 66 | INTRA_ANGULAR2 . . . |
| | INTRA_ANGULAR66 |
| 81 . . . 83 | INTRA_LT_CCLM, INTRA_L_CCLM, |
| | INTRA_T_CCLM |

Meanwhile, the intra prediction types (or additive intra prediction modes, etc.) may include at least one of the above-described LIP, PDPC, MRL, ISP, and MIP. The intra prediction types may be indicated based on intra prediction type information, and the intra prediction type information may be implemented in various forms. As an example, the intra prediction type information may include intra prediction type index information indicating one of the intra prediction types. As another example, the intra prediction type information may include at least one of reference sample line information (e.g., intra_luma_ref_idx) indicating whether MRL is applied to the current block and which reference sample line is used when MRL is applied, ISP flag information (e.g., intra_subpartitions_mode_flag) indicating whether ISP is applied to the current block, ISP type information (e.g., intra_subparititions_split_flag) indicating partition types of sub-partitions when ISP is applied, and flag information indicating whether PDPC is applied or flag information indicating whether LIP is applied. In addition, the intra prediction type information may include an MIP flag (or referred to as “intra_mip_flag”) indicating whether MIP is applied to the current block.

### Overview of Template-Based Intra Mode Derivation (TIMD)

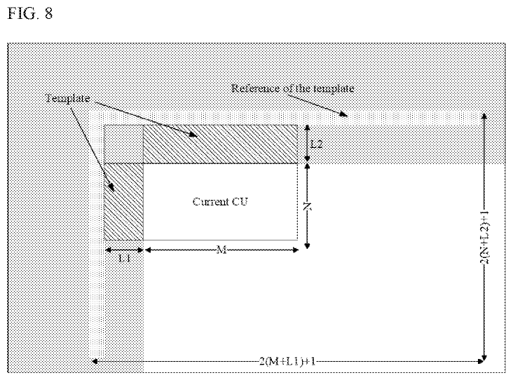

FIG. 8 is a diagram showing template areas used in a TIMD mode according to the present disclosure. For intra prediction mode (IPM) intra modes of neighboring intra blocks and inter blocks, sums of absolute transformed difference (SATDs) between a prediction block predicted from a template area and actually reconstructed samples may be calculated, and then a mode with the smallest SATD may be selected as an intra mode of a current block.

In other words, two intra prediction modes with the two lowest SATDs are selected as TIMD modes. The two TIMD modes are fused with weights, and this weighted intra prediction is used to encode a current coding unit (CU). PDPC may be included in a derivation process of a TIMD mode.

Costs of the two selected modes are compared with a threshold, and in a test, two cost factors are applied as follows.

$$costMode 2 < 2 * costMode 1$$

When the above condition holds true, fusion is applied, and otherwise, only mode 1 is used.

Weights of the modes are calculated using SATD costs thereof as follows.

$$weight 1 = costMode 2 / ( costMode 1 + costMode 2 )$$

$$weight 2 = 1 - weight 1$$

### Template Matching (TM)

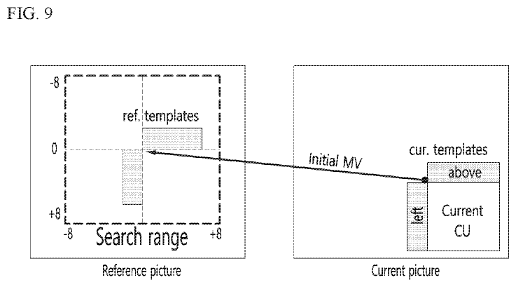

FIG. 9 is a diagram illustrating a TM-based encoding/decoding method according to the present disclosure.

TM is a motion vector derivation method performed at a decoder stage and is a method of refining motion information of a current block (e.g., a current CU) by detecting a template in a reference picture (hereinafter, “reference template”) that is most similar to a template adjacent to the current block (hereinafter, “current template”). The current template may be a top neighboring block and/or a left neighboring block of the current block or a part of these neighboring blocks. In addition, the reference template may be determined to have the same size as the current template.

As shown in FIG. 9, when an initial motion vector of a current block is derived, a search for a better motion vector may be performed in a neighboring area of the initial motion vector. For example, a range of the neighboring area in which the search is performed may be within a [−8, +8]-pel search area from the initial motion vector. Also, a size of a search step for performing the search may be determined based on an adaptive motion vector resolution (AMVR) mode of the current block. Further, TM may be performed as a continuation of a bilateral matching process in a merge mode.

When a prediction mode of the current block is an adaptive motion vector prediction (AMVP) mode, a motion vector predictor (MVP) candidate may be determined based on a TM error. For example, an MVP candidate that minimizes an error between a current template and a reference template may be selected. Subsequently, TM for refining the motion vector may be performed for the selected MVP candidate. Here, TM for refining the motion vector may not be performed for non-selected MVP candidates.

More specifically, refinement of the selected MVP candidate may be started from full-pel (integer-pel) accuracy within a [−8, +8]-pel search area using an iterative diamond search. Alternatively, in the case of a 4-pel AMVR mode, the refinement may be started from 4-pel accuracy. Subsequently, a search may follow at half-pel and/or quarter-pel accuracy in accordance with an AMVR mode. According to the search process, MVP candidates may maintain the same motion vector accuracy as indicated by an AMVR mode even after the TM process. When a difference between a previous minimum cost and a current minimum cost is smaller than a threshold during the iterative search process, the search process ends. The threshold may be equal to the number of samples in a block area, that is, the block. Table 2 is an example of search patterns in accordance with AMVR modes and merge modes accompanied by AMVR.

TABLE 2

| | AMVR mode | | | | | |
|---|---|---|---|---|---|---|
| | | Full- | Half- | Quarter- | Merge mode | |
| Search pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

When a prediction mode of the current block is a merge mode, a similar search method may be applied to a merge candidate indicated by a merge index. As shown in Table 2 above, TM may be performed up to 1/8-pel accuracy or skipped for half-pel accuracy or lower, which may be determined dependently on whether an alternative interpolation filter is used in accordance with merge motion information. Here, the alternative interpolation filter may be a filter used when an AMVR mode is a half-pel mode. In addition, when TM is available, the TM may be performed as a separate process depending on whether bilateral matching (BM) is available, or may be performed as an additional motion vector refinement process between block-based BM and sub-block-based BM. Whether TM is available and/or whether BM is available may be determined in accordance with an availability condition check. In the above description, accuracy of a motion vector may be accuracy of a motion vector difference (MVD).

### Intra Block Copy (IBC) Mode

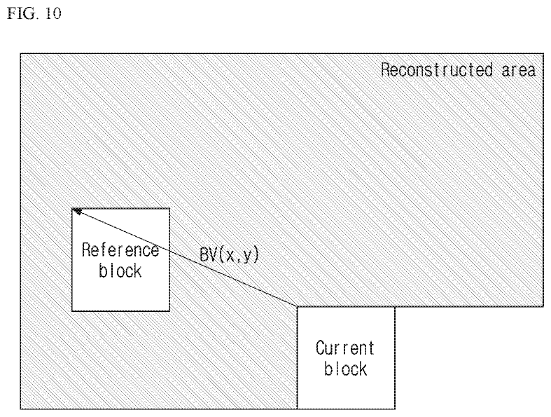

An IBC mode may be a mode for detecting an optimal block vector (BV) through block matching between a current block and reference blocks. Also, in the IBC mode, multiple BV candidates may be managed as a candidate list. One of the BV candidates in the candidate list may be signaled, and BV information may also be signaled. FIG. 10 is a diagram showing a BV in the IBC mode according to an embodiment of the present disclosure. Here, the BV may indicate a displacement from the current block to an already reconstructed reference block in a current picture.

### Fraction-Pel Extension

An expression of an IBC BV may be extended to fractional-pel resolutions. Therefore, to derive prediction samples located at non-integer phases in a reconstructed area of a current picture, an interpolation filter may be necessary. Options of BV resolutions may be extended to include 1/4-pel resolution in addition to full-pel resolution and 4-pel resolution. Here, information indicating the 1/4-pel, full-pel, or 4-pel resolution may be signaled. Interpolation filters applied to luma and chroma components of an IBC block may be identical to an 8-tap luma filter and a chroma filter used for motion compensation, respectively.

### IBC Reference Area

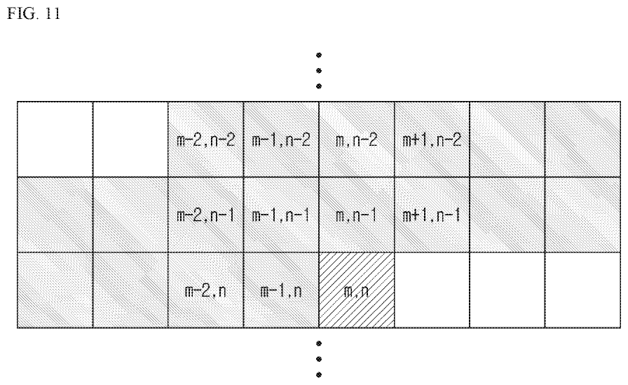

A reference area in the IBC mode may be extended to two coding tree unit (CTU) rows above a current CTU. FIG. 11 is a diagram showing a reference area in the IBC mode according to an embodiment of the present disclosure. In other words, FIG. 11 is a diagram showing reference areas of a CTU (m, n). Specifically, to code the CTU (m, n), reference areas may include CTUs with indexes (m−2, n−2) to (W, n−2), (0, n−1) to (W, n−1), and (0, n) to (m, n). Here, W may be a maximum horizontal index in a current tile, slice or picture. In other words, W may be a maximum width in a current tile, slice, or picture. When a CTU size (width) is 256, reference areas may be limited to one CTU row above a current CTU. This setting (restriction) may ensure that, when a CTU size is 128 or 256, IBC does not require additional memory in a current encoder test model (ETM) platform. A sample-specific BV search (or local search) range may be limited horizontally to [−(C<<1), C>>2] and vertically to [−C, C>2] to adapt to reference area expansion. Here, C may be a size of a CTU.

### General Derivation of Prediction Samples for Chromatic Components

When intra prediction is performed on a current block, a luma component block (luma block) and a chroma component block (chroma block) of the current block may be predicted. In this case, an intra prediction mode for the chroma component (chroma block) and an intra prediction mode for the luma component (luma block) may be separately set.

For example, the intra prediction mode for the chroma component may be indicated based on intra chroma prediction mode information, which may be signaled in the form of an intra_chroma_pred_mode syntax element. For example, the intra chroma prediction mode information may indicate one of candidate modes including at least one of the planar mode, the DC mode, the vertical mode, the horizontal mode, a derived mode (DM), the L_CCLM mode, the T_CCLM mode, and the LT_CCLM mode. DM may also be referred to as “direct mode.” The CCLM may be referred to as “LM.”

Meanwhile, the DM and CCLM are dependent intra prediction modes for predicting a chroma block using information on a luma block. The DM may indicate a mode in which an intra prediction mode identical to an intra prediction mode for the luma component is applied as an intra prediction mode for the chroma component. Also, the CCLM may indicate intra prediction modes in which samples derived by subsampling reconstructed samples of the luma block during the process of generating a prediction block of the chroma block, and then applying a CCLM parameter (e.g., a and/or B) to subsampled samples, are used as prediction samples of the chroma block.

### Overview of Multiple Direct Modes (MDM) for Chroma Intra Coding

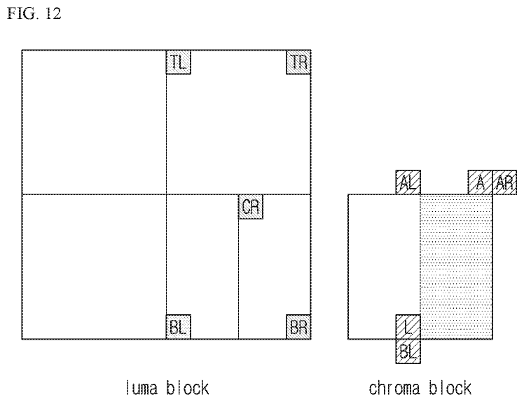

The MDM may be applied to a current chroma block. The MDM may be a mode for extensively using the DM which is a single mode as a plurality of modes. FIG. 12 is a diagram showing positions of neighboring samples used in the MDM mode according to an embodiment of the present disclosure. In determining an intra prediction mode of a chroma image, a DM candidate list may be generated as follows, and then a final DM may be selected.
Intra prediction modes at center right (CR), top left (TL), top right (TR), bottom left (BL), and bottom right (BR) positions of a luma block at the same position.
Intra prediction modes of left (L), above (A), bottom left (BL), above right (AR), and above left (AL) blocks which are neighboring blocks of the current chroma block.
The planar mode and DC mode
Angular nodes obtained by adding or subtracting 1 to or from the previously selected angular modes.
The vertical mode, the horizontal mode, and modes 2, 34, 66, 10, and 26 (when there are 65 directional modes).
When five prediction modes are not selected, the previously selected modes are copied and selected.

### Overview of Multi-Model LM (MMLM)

CCLM modes may be extended to MMLM modes. For example, three MMLM modes may be added. Neighboring samples reconstructed in each MMLM mode may be categorized into two groups using a threshold. The threshold may be an average of reconstructed luma samples. An LM of each group may be derived using a linear-mean-square (LMS) algorithm. The LMS algorithm may also be used to derive an LM in CCLM modes.

When the MMLM is used, there may be two or more LMs between luma samples and chroma samples in a CU. In this method, neighboring luma samples and neighboring chroma samples of a current block may be categorized into some groups. Also, each group may be used as a training set for deriving an LM. In other words, a CCLM parameter (e.g., a and/or B) may be derived from each group. In addition, samples in a current luma block may be categorized in the same way as neighboring luma samples.

In this method, neighboring samples may be categorized into M groups. Here, M may be 2 or 3. When M is 2 or 3, an MMLM method may be designed with two chroma prediction modes MMLM2 and MMLM3 in addition to the original LM mode. An image encoding apparatus may select an optimal mode in a rate-distortion optimization (RDO) process and signal the selected optimal mode.

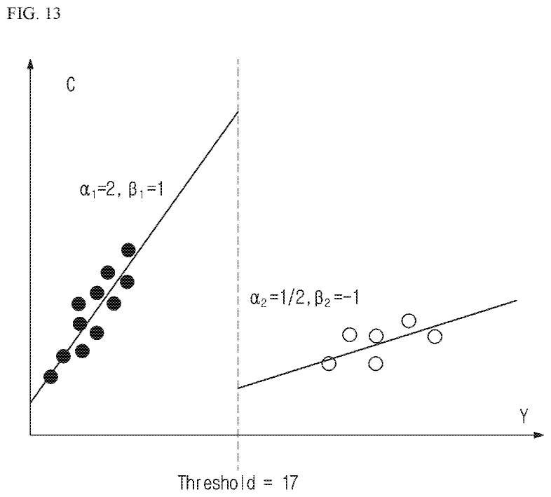

FIG. 13 is a view showing a method of categorizing neighboring samples into two groups according to an embodiment of the present disclosure. FIG. 13 shows the case where M is 2. Referring to FIG. 13, a threshold may be calculated as an average of reconstructed neighboring luma samples. Neighboring luma samples with Rec′_{L}[x,y] of the threshold or less may be categorized into group 1, and neighboring luma samples with Rec′_{L}[x,y] exceeding the threshold may be categorized into group 2. Two models of group 1 and group 2 may be derived using the following equation 1.

$$\{ \begin{matrix}Pre {d}_{C} [ x , y ] = {α}_{1} \times {Rec}_{L}^{′} [ x , y ] + {β}_{1} if {Rec}_{L}^{′} [ x , y ] \leq Threshold \\ Pre {d}_{C} [ x , y ] = {α}_{2} \times {Rec}_{L}^{′} [ x , y ] + {β}_{2} if {Rec}_{L}^{′} [ x , y ] \leq Threshold\end{matrix} \qquad [ Equation 1 ]$$

### Overview of CCLM

A CCLM mode may be applied to a current chroma block. The CCLM mode is an intra prediction mode in which the correlation between a luma block and a chroma block corresponding to the luma block is used. An LM may be derived based on neighboring samples of the luma block and neighboring samples of the chroma block, and a mode in which prediction samples of the chroma block are derived may be indicated based on the LM and reconstructed samples of the luma block. Specifically, when the CCLM mode is applied to the current chroma block, parameters of the LM may be derived based on neighboring samples used for intra prediction of the current chroma block and neighboring samples used for intra prediction of the current luma block.

To reduce redundancy of cross-components, a CCLM prediction mode may be used in the present disclosure. Here, a chroma sample may be predicted based on reconstructed luma samples of the same CU using an LM. For example, the LM may be the same as shown in equation 2 below.

$${pred}_{C} ( i , j ) = α \cdot {rec}_{L}^{′} ( i , j ) + β \qquad [ Equation 2 ]$$

Here, pred_{C}(i,j) may indicate a prediction sample at coordinates (i, j) of a current chroma block in a current CU, and rec_{L}′(i,j) may indicate a reconstructed sample at the coordinates (i, j) of a current luma block in the current CU. Alternatively, rec_{L}′(i,j) may indicate a down-sampled reconstructed sample of the current luma block.

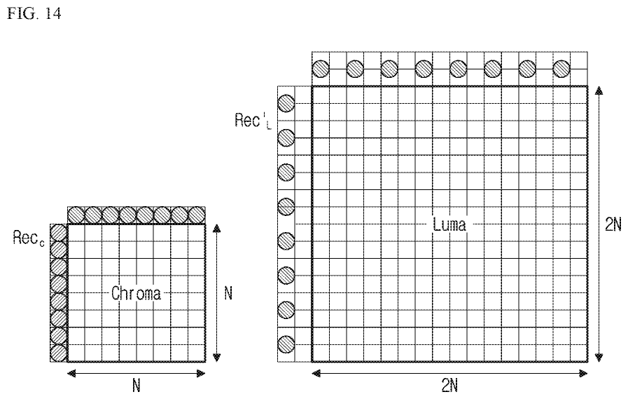

FIG. 14 is a diagram showing positions of neighboring samples used for deriving a CCLM parameter according to an embodiment of the present disclosure. FIG. 9 shows positions of left neighboring samples, positions of top neighboring samples, and examples of samples adjacent to a current block related to a CCLM mode.

A CCLM parameter (e.g., α and/or β) may be derived using a maximum of four adjacent chroma samples and down-sampled luma samples corresponding to the adjacent chroma samples. Alternatively, CCLM parameters may be derived using N neighboring chroma samples and down-sampled luma samples corresponding to the neighboring chroma samples. When a current chroma block has a size of W×H, W′ and H′ may be set as follows. W′ may indicate a range in which top neighboring chroma samples used for deriving CCLM parameters are located. H′ may indicate a range in which left neighboring chroma samples used for deriving CCLM parameters are located.
When a CCLM mode is applied, W′=W, H′=H.
When a CCLM_A mode is applied, W′=W+H.
When a CCLM_L mode is applied, H′=H+W.

Positions of top neighboring samples may be represented as S[0, −1] . . . . S[W′−1, −1], and positions of left neighboring samples may be represented as S[−1, 0] . . . . S[−1, H′, −1]. In this case, four samples may be selected as follows.

When a CCLM mode is applied and both top and left neighboring samples are usable: S[W′/4, −1], S[3 W′/4, −1], S[−1, H′/4], and S[−1, 3H′/4].

When the CCLM_A mode is applied or only top neighboring samples are usable: S[W′/8, −1], S[3 W′/8, −1], S[5 W′/8, −1], and S[7 W′/8, −1].

When the CCLM_L mode is applied or only left neighboring samples are usable: S[−1, H′/8], S[−1, 3H′/8], S[−1, 5H′/8], and S[−1, 7H′/8].

Four neighboring luma samples at positions that are selected in the above-described manner may be obtained through down-sampling. Four comparisons may be performed to detect two small values (x⁰_{A} and x¹_{A}) and two large values (x⁰_{B} and x¹_{B}) among the four luma samples. Chroma sample values corresponding to the four neighboring samples may be represented as y⁰_{A}, y¹_{A}, y⁰_{B}, and y¹_{B}. In this case, x_{A}, x_{B}, y_{A}, and y_{B} may be derived through equation 3 below.

$${X}_{a} = ( {x}_{A}^{0} + {x}_{A}^{1} + 1 ) >> 1 ; \qquad [ Equation 3 ]$$

$${X}_{b} = ( {x}_{B}^{0} + {x}_{B}^{1} + 1 ) >> 1 ;$$

$${Y}_{a} = ( {y}_{A}^{0} + {y}_{A}^{1} + 1 ) >> 1 ;$$

$${Y}_{b} = ( {y}_{B}^{0} + {y}_{B}^{1} + 1 ) >> 1$$

The CCLM parameters α and β may be derived through equation 4 below.

$$a = \frac{{Y}_{a} - {Y}_{b}}{{X}_{a} - {X}_{b}} \qquad [ Equation 4 ]$$

$$β = {Y}_{b} - a \cdot {X}_{b}$$

According to an embodiment of the present disclosure, CCLM parameters may be derived using top neighboring samples and left neighboring samples, and the CCLM parameters may also be used in two other LM modes (an LM_A mode and an LM_L mode). According to the embodiment of the present disclosure, In the LM_A mode, only top neighboring samples may be used to derive CCLM parameters. In this case, to obtain more samples, top neighboring samples may be extended up to a sample at W+H position. On the other hand, in the LM_L mode, only left neighboring samples may be used to derive CCLM parameters. In this case, to obtain more samples, left neighboring samples may be extended up to a sample at H+W position. As another example, in a non-square block, LM_A mode, top neighboring samples may be extended up to a sample at W+W position, and left neighboring samples may be extended up to a sample at H+H position.

To match positions of chroma samples in a 4:2:0 video sequence, two types of down-sampling filters may be applied to luma samples to achieve a 2:1 down-sampling ratio in both the horizontal and vertical directions. The down-sampling filters may be specified by an SPS level flag. The down-sampling filters may be applied to obtain a luma sample corresponding to a chroma sample at a certain position (i, j). The two down-sampling filters may be represented as shown in equation 5 and equation 6 below.

$${rec}_{L}^{′} ( i , j ) = [ {rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] >> 3 \qquad [ Equation 5 ]$$

$${rec}_{L}^{′} ( i , j ) = [ {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] >> 3 \qquad [ Equation 6 ]$$

When a boundary of a current luma block corresponds to a CTU boundary, only one luma reference line may be used to generate down-sampled luma samples.

Derivation of the parameters may be performed as an image decoding process and may not be performed by an encoder search operation alone. As a result, syntax may not be used to transmit an α and/or β value to an image decoding apparatus.

According to the present disclosure, a total of eight intra prediction modes may be used in an intra chroma prediction mode encoding process. The eight intra prediction modes may include five existing intra prediction modes and three CCLM modes (CCLM, LM_A, and LM_L). An intra chroma prediction mode signaling and derivation process will be described below with reference to table 3 and table 4 below.

TABLE 3

| | lumaIntraPredMode | | | | |
|---|---|---|---|---|---|
| intra_chroma_pred_mode[ xCb ][ yCb ] | 0 | 50 | 18 | 1 | X ( 0 <= X <= 66 ) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |

TABLE 4

| | lumaIntraPredMode | | | | |
|---|---|---|---|---|---|
| intra_chroma_pred_mode[ xCb ][ yCb ] | 0 | 50 | 18 | 1 | X ( 0 <= X <= 66 ) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 81 | 81 | 81 | 81 | 81 |
| 5 | 82 | 82 | 82 | 82 | 82 |
| 6 | 83 | 83 | 83 | 83 | 83 |
| 7 | 0 | 50 | 18 | 1 | X |

Intra chroma prediction mode encoding may be dependent on an intra prediction mode of a luma block corresponding thereto. Since separate block partition structures for luma and chroma components are activated in an I-slice, one chroma block may correspond to a plurality of luma blocks. Therefore, in a chroma DM mode, an intra prediction mode of a corresponding luma block covering a central position of a current chroma block may be directly applied.

Table 3 is a matching table for deriving an intra chroma prediction mode when the CCLM is not applicable, and table 4 is a matching table for deriving an intra chroma prediction mode when the CCLM is applicable. As shown in the tables, an intra chroma prediction mode may be determined based on an intra luma prediction mode for a luma block (e.g., when DUAL_TREE is applied) covering a central bottom-right sample of a current block or a chroma block and a value of signaled intra chroma prediction mode (intra_chroma_pred_mode) information. Indexes of IntraPredModeC[xCb][yCb] derived from the foregoing tables may correspond to indexes of the intra prediction modes shown in the above-described table 1.

### Overview of Gradient Linear Model (GLM)

In a YUV 4:2:0 color format, a GLM may be used for predicting a chroma sample from a luma sample gradient. The GLM supports two modes, a 2-parameter GLM prediction mode and a 3-parameter GLM prediction mode.

Compared to a CCLM prediction mode, in a GLM prediction mode, a 2-parameter GLM employing luma sample gradients may be used to derive an LM instead of down-sampling values of corresponding luma samples. Specifically, when the 2-parameter GLM prediction mode is applied, down-sampled luma sample L which is used as an input during a CCLM prediction process may be replaced with luma sample gradient G. Other processes (e.g., parameter derivation, a linear transformation of prediction samples, etc.) performed in the CCLM prediction mode are applied to the GLM prediction mode in the same manner. Equation 7 below may be a formula used to generate a prediction sample in the 2-parameter GLM prediction mode.

$$C = α \cdot G + β \qquad [ Equation 7 ]$$

In the 3-parameter GLM prediction mode, chroma samples may be predicted based on all luma values that are down-sampled using a luma sample gradient and other parameters. Model parameters of the 3-parameter GLM prediction model may be derived from rows and columns of six adjacent samples through a label distribution learning (LDL) decomposition-based mean square error (MSE) minimization method. Equation 8 below may be a formula used to generate a prediction sample in the 3-parameter GLM prediction mode.

$$C = {α}_{0} \cdot G + {α}_{1} \cdot L + {α}_{2} \cdot β \qquad [ Equation 8 ]$$

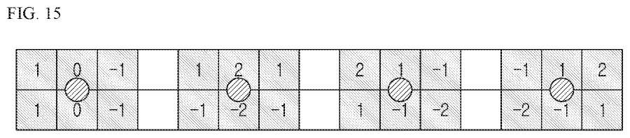

FIG. 15 is a diagram showing a gradient pattern for a GLM according to an embodiment of the present disclosure. When the CCLM prediction mode is available for a current CU, one flag indicating whether a GLM prediction mode is available for both Cb and Cr components. When a GLM prediction mode is available, another flag indicating which one of two GLM modes GLM mode will be used and a syntax element for selecting one of four gradient filters for gradient calculation may be further signaled.

### Overview of Convolutional Cross-Component Model (CCCM)

Chroma samples may be predicted from luma samples that are reconstructed by applying a concept similar to that performed by the foregoing CCLM mode(s). For example, when a CCCM prediction mode is performed, reconstructed luma samples may be used to predict chroma samples. When chroma sub-sampling is used, reconstructed luma samples may be down-sampled to match a low-resolution chroma grid (block). Also, a CCCM mode may include a single model or multiple models. Here, the multiple models may be a model employing two models. One of the two models included in the multiple models may be applied to a sample with an average of luma reference samples or more. The other one of the two models included in the multiple models may be applied to a sample with less than the average of the luma reference samples. Here, the luma reference samples may be samples included in a luma reference area adjacent to a corresponding luma block. The multi-model CCCM mode may be applied to a prediction unit (PU) with 128 or more available reference samples. However, the present disclosure is not limited thereto, and the multi-model CCCM mode may be applied to a PU with less than 128 available reference samples. The number of available reference samples based on which it is determined whether the CCCM mode is applicable to a PU is not limited to 128 and may be, for example, 256, 64, or the like. Alternatively, the number of available reference samples may be determined differently depending on a size of a PU.

### Convolutional Filter

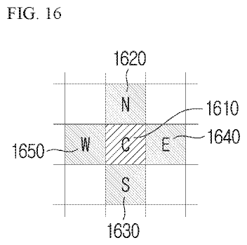

A 7-tap filter proposed in the CCCM prediction modes may be composed of a 5-tap filter, a nonlinear term, and a bias term. Here, the 5-tap filter may be a plus-sign-shaped spatial filter that employs neighboring luma samples existing at plus-shaped positions based on a corresponding luma sample in a corresponding luma block. Components constituting the 5-tap filter will be described in detail below with reference to FIG. 16.

FIG. 16 is a diagram showing a corresponding luma sample and neighboring luma samples. Components constituting the 5-tap filter may a corresponding luma sample (C) 1610 corresponding to a prediction-target chroma sample and a top/northern (N) neighboring luma sample 1620, a bottom/southern(S) neighboring luma sample 1630, a right/eastern (E) neighboring luma sample 1640, and a left/western (W) neighboring luma sample 1650 of the corresponding luma sample.

A nonlinear term P which is one component constituting the 7-tap filter may be represented as the square of a corresponding luma sample value C and may be scaled as a sample value range of content. Equation 9 below may be an example of deriving the nonlinear term P. Also, equation 10 may be an example of deriving the nonlinear term P in the case of 10-bit content.

$$P = ( C * C + midVal ) >> bitDepth \qquad [ Equation 9 ]$$

$$P = ( C * C + 512 ) >> 10 \qquad [ Equation 10 ]$$

A bias term B which is one component constituting the 7-tap filter may be represented as a scalar offset between an input and an output. This may be similar to an offset term of the CCLM. Also, the bias term B may be set to a median of a chroma sample. For example, in the case of 10-bit content, the bias term B may be 512.

An output of the 7-tap filter may be calculated as the convolution between a filter coefficient Ci and an input value, and may be clipped to a range of valid chroma samples. Equation 11 below may be an example of deriving a prediction sample value of a chroma sample using a CCCM prediction mode.

$$PredChromaVal = c 0 C + c 1 N + c 2 S + c 3 E + c 4 W + c 5 P + c 6 B \qquad [ Equation 11 ]$$

An image encoding/decoding method according to an embodiment of the present disclosure will be described in detail below.

### Embodiment 1

An embodiment of the present disclosure proposes a method of improving chroma prediction performance by utilizing BV information. A chroma block may be predicted using the correlation between a luma block and a chroma block corresponding to the luma block. An LM-based prediction mode, such as the CCLM, the CCCM, etc., may be an example. In this case, according to the present disclosure, a relational expression may be obtained using previously reconstructed neighboring samples of a current chroma block and previously reconstructed samples neighboring on a luma block at a position corresponding to the previously reconstructed neighboring samples. However, when the luma block at the corresponding position is in the IBC mode, the correlation between the luma block and an adjacent block may be relatively low. Therefore, using the previously reconstructed samples neighboring on the corresponding luma block may degrade prediction performance.

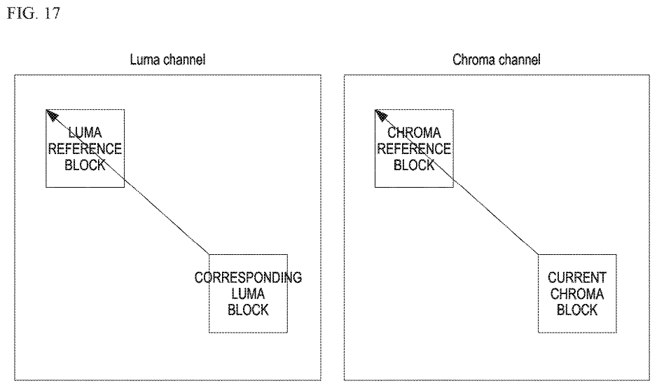

Therefore, according to the present disclosure, BV information of a luma block corresponding to a current chroma block may be utilized to obtain a relational expression used in predicting the current chroma block. FIG. 17 is a diagram showing BVs when a corresponding luma block according to an embodiment of the present disclosure is in the IBC mode. Specifically, according to the present disclosure, a relational expression may be obtained based on BV information of a corresponding luma block using the correlation between a luma reference block indicated by a corresponding BV and a chroma reference block indicated by a corresponding BV. A prediction block of a current chroma block may be generated by applying the obtained relational expression to the corresponding luma block of the current chroma block. In this case, to generate a relational expression using the correlation between the luma reference block of the corresponding luma block and the chroma reference block of the current chroma block, the luma reference block may be scaled (i.e., down-sampled) in accordance with the chroma reference block. Also, when the corresponding luma block is coded through intra template matching prediction (IntraTMP), IBC, etc., BV information stored during the intraTMP or IBC process may be utilized as the BV information of the corresponding luma block.

An embodiment of the present disclosure may be applied to the CCLM, the above CCLM (T_CCLM) for deriving/applying above reconstructed neighboring samples, the left CCLM (L_CCLM) for deriving/applying left reconstructed neighboring samples, the multi-model CCLM, GLM, and CCCM for deriving/applying multiple models, the multi-model CCCM for deriving/applying multiple models, the above CCCM for deriving/applying above reconstructed neighboring samples, the left CCCM for deriving/applying left reconstructed neighboring samples, the non-down-sampled CCCM, and the like.

A weighted sum of a chroma prediction block generated according to an embodiment of the present disclosure and a non-CCLM and/or non-CCCM intra chroma mode may be calculated. In other words, a weighted sum of a chroma prediction block generated according to the above-described embodiment and a prediction block generated in a non-CCLM and/or non-CCCM intra chroma mode may be calculated. For example, a final prediction block may be generated by calculating a weighted sum of a prediction block generated in the DM, decoder-side intra mode derivation (DIMD), or one of the four default modes (planar, vertical, horizontal, and DC modes) and a chroma prediction block generated according to an embodiment of the present disclosure.

Whether to apply a method utilizing BV information according to the present disclosure may be signaled. Alternatively, it may be derived by the image encoding apparatus 100 and/or the image decoding apparatus 200 using a predetermined method.

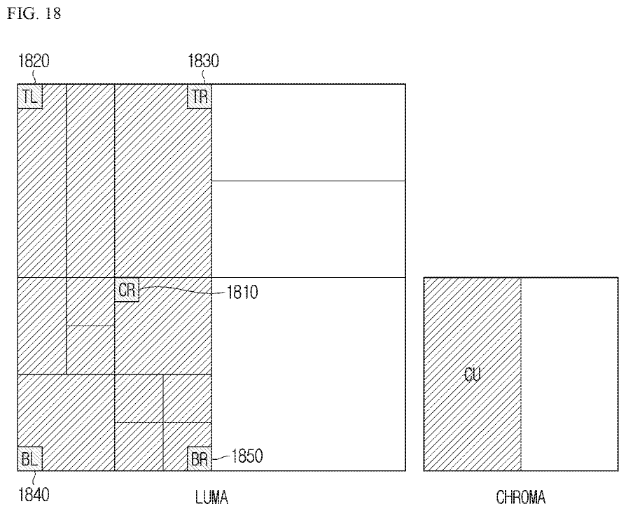

According to an embodiment of the present disclosure, BV information stored in one or more luma blocks corresponding to an current chroma block and/or BV information stored around the one or more corresponding luma blocks may be utilized to generate a prediction block of the current chroma block. For example, referring to FIG. 18, a current chroma block may be predicted by utilizing BV information stored at N positions including a luma block corresponding to the current chroma block according to the present disclosure. Here, N may be an integer of 1 or more, and the corresponding position may include a predefined position. Therefore, according to the present disclosure, a relational expression may be obtained using the correlation between a luma reference block indicated by one piece of the BV information stored in the N positions including the corresponding luma block and a chroma reference block indicated by the corresponding BV. The obtained relational expression may be applied to the corresponding luma block of the current chroma block, and accordingly, a chroma prediction block which is a prediction block of the current chroma block may be generated.

According to the present disclosure, when the intraTMP or IBV mode is applied to a corresponding luma block, BV information of the corresponding luma block may be BV information stored when the intraTMP or IBC mode is applied to the corresponding luma block. When there are several BV candidates, one of the BV candidates may be signaled. Alternatively, BV information may be derived using a method predefined between the image encoding apparatus 100 and the image decoding apparatus 200 without signaling of BV information. For example, all the several BV candidates may be used. Alternatively, multiple models may be generated using only some BV candidates. Alternatively, a single or multiple models may be generated using one or more BV candidates at a specific luma block position.

The order of searching for a BV according to an embodiment of the present disclosure may be determined using various methods as will be described below, and the order may be defined in advance between the image encoding apparatus 100 and the image decoding apparatus 200. The following order of searching for a BV will be described with reference to FIG. 18.

Method 1. A BV that appears (is stored) first is used. In this case, the search order may be C 1810, TL 1820, TR 1830, BL 1840, and BR 1850. In other words, the search is performed in order of C 1810, TL 1820, TR 1830, BL 1840, and BR 1850, and then the first appearing BV is used.

Method 2. A BV at a position where multiple BVs appear first is used. The search order may be C 1810, TL 1820, TR 1830, BL 1840, and BR 1850. For example, when a single BV is stored at a position of C 1810, the corresponding BV may not be used. A single BV or no BV is stored at all the positions, a method identical to method 1 is used. In other words, when a plurality of BVs are not stored at any position, a method identical to method 1 is used.

Method 3. A BV at a position where a single BV appears (is stored) first is used. The search order may be C 1810, TL 1820, TR 1830, BL 1840, and BR 1850. For example, when multiple BVs are stored at the position of C 1810, storage of the BVs may be skipped. When multiple BVs or no BVs are stored at all the positions, a method identical to method 1 is used. In other words, when there is no position at which only one BV is stored, a method identical to method 1 is used.

Method 4. When multiple models are generated, the search order may be C 1810, TL 1820, TR 1830, BL 1840, and BR 1850. Here, all or some stored BVs may be used in the search order. For example, when multiple BVs are stored at a specific position during the search, only the BVs at the position may be used. In other words, to generate multiple models, BVs at a position where multiple BVs are stored may be used. Alternatively, to utilize K BVs, all defined search positions may be searched until K BVs are obtained. K may be a natural number, which may be a value predefined between the image encoding apparatus 100 and the image decoding apparatus 200.

C 1810 in the above-described methods 1 to 4 may be a top-left luma sample in a central one of the plurality of corresponding luma blocks. TL 1820 may be a top-left luma sample in a top-left one of the plurality of corresponding luma blocks. TR 1830 may be a top-right luma sample in a top-right one of the plurality of corresponding luma blocks. BL 1830 may be a bottom-left luma sample in a bottom-left one of the plurality of corresponding luma blocks. BR 1850 may be a bottom-right luma sample in a bottom-right one of the plurality of corresponding luma blocks.

The search order of C 1810, TL 1820, TR 1830, BL 1840, and BR 1850 mentioned in the above-described methods 1 to 4 is merely illustrative, and the search may be performed in various orders. Alternatively, the search order may be determined by an agreement between the image encoding apparatus 100 and the image decoding apparatus 200.

According to an embodiment of the present disclosure, a BV may be searched for using different methods depending on whether there is a single model or multiple models. For example, a single model may obtain a BV using method 3, and multiple models may obtain a BV using method 2.

An embodiment according to the present disclosure may be applied only when a dual tree method is applied. Also, whether to apply the method utilizing BV information may be signaled or derived by the image encoding apparatus 100/image decoding apparatus 200 using a predefined method. For example, whether BV information is utilized may be determined in sequence parameter set (SPS), picture parameter set (PPS), adaptation parameter set (APS), picture, slice, CTU, or CU units.

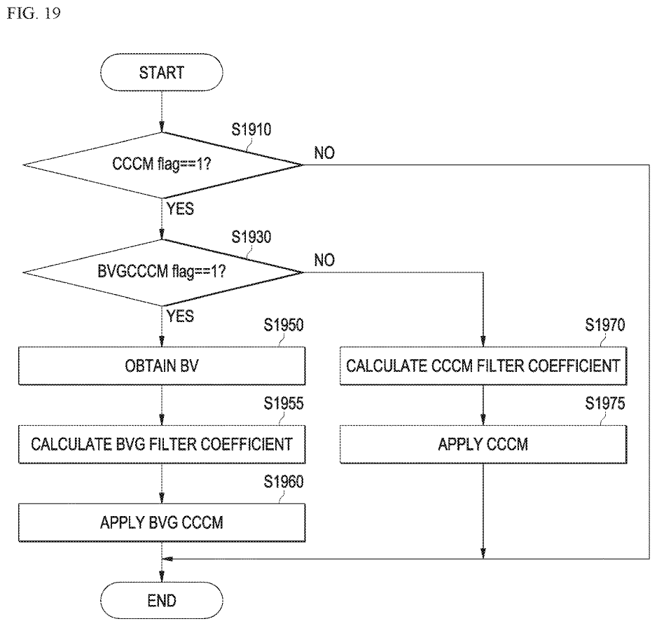

FIG. 19 is a flowchart of a method of generating a chroma prediction block according to an embodiment of the present disclosure. Referring to FIG. 19, the image decoding apparatus 200 may check whether a CCCM flag has a value of 1 (S1910). Here, the CCCM flag may be a flag indicating whether to apply the CCCM. Alternatively, the CCCM flag may be a flag indicating whether the CCCM is available.

When the CCCM flag has a value of 1 (Yes in S1910), the image decoding apparatus 200 may check whether a block vector guided CCCM (BVGCCCM) flag has a value of 1 (S1930). The BVGCCCM flag may be a flag indicating whether to apply a BVGCCCM. Alternatively, the BVGCCCM flag may be a flag indicating whether the BVGCCCM is available.

When the BVGCCCM flag has a value of 1 (Yes in S1930), the image decoding apparatus 200 may obtain a BV (S1950). In other words, the image decoding apparatus 200 may obtain a BV (or BV information) of a luma block corresponding to a current chroma block. In addition, the image decoding apparatus 200 may obtain BVs (or BV information) stored around the luma block corresponding to the current chroma block.

The image decoding apparatus 200 may calculate a BVG filter coefficient (S1955). The image decoding apparatus 200 may calculate the BVG filter coefficient using the correlation between a luma reference block indicated by one or many of the obtained BVs (or BV information) and a chroma reference block indicated by the corresponding BV. Here, the BVG filter coefficient may be a relational expression calculated using the correlation between a luma reference block and a chroma reference block. A method of calculating a BVG filter coefficient may be identical to a method used in the CCCM, a multi-model CCCM, a gradient and location-based CCCM (GL-CCCM), the GLM, a non-down-sampled CCCM, and the like.

The image decoding apparatus 200 may apply BVG CCCM (S1960). In other words, the image decoding apparatus 200 may apply the BVG filter coefficient to the corresponding luma block. By applying the BVG filter coefficient to the corresponding luma block, the image decoding apparatus 200 may generate a chroma prediction block.

When the BVGCCCM flag does not have a value of 1 (No in S1930), the image decoding apparatus 200 may calculate a CCCM filter coefficient (S1970). Specifically, the image decoding apparatus 200 may calculate a filter coefficient between the corresponding luma block and the current chroma block in the same manner as in the CCCM.

The image decoding apparatus 200 may apply CCCM (S1975). In other words, the image decoding apparatus 200 may apply the calculated CCCM filter coefficient to the corresponding luma filter. By applying the calculated CCCM filter coefficient to the corresponding luma filter, the image decoding apparatus 200 may generate a chroma prediction block.

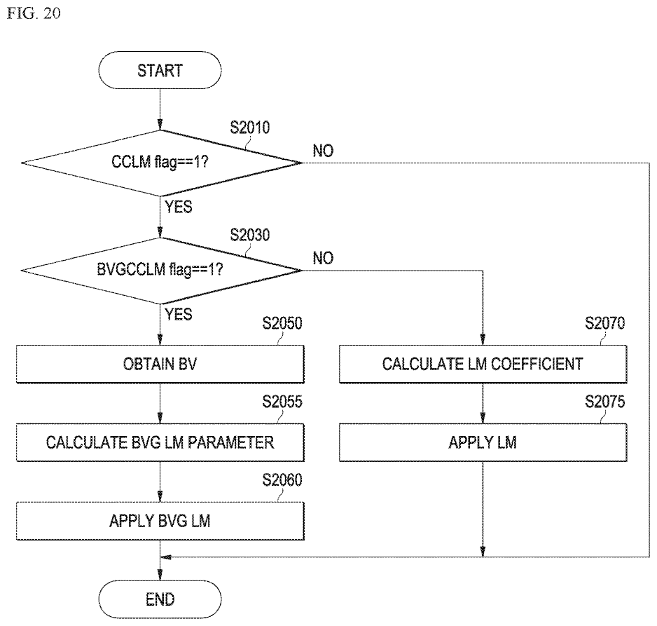

FIG. 20 is a flowchart of a method of generating a chroma prediction block according to an embodiment of the present disclosure. Referring to FIG. 20, the image decoding apparatus 200 may check whether a CCCM flag has a value of 1 (S2010). Here, the CCCM flag may be a flag indicating whether to apply the CCCM. Alternatively, the CCCM flag may be a flag indicating whether the CCCM is available.

When the CCCM flag has a value of 1 (Yes in S2010), the image decoding apparatus 200 may check whether a BVGCCLM flag has a value of 1 (S2030). The BVGCCLM flag may be a flag indicating whether to apply the BVGCCLM. Alternatively, the BVGCCLM flag may be a flag indicating whether the BVGCCLM is available.

When the BVGCCLM flag has a value of 1 (Yes in S2030), the image decoding apparatus 200 may obtain a BV (S2050). In other words, the image decoding apparatus 200 may obtain a BV (or BV information) of a luma block corresponding to a current chroma block. In addition, the image decoding apparatus 200 may obtain BVs (or BV information) stored around the luma block corresponding to the current chroma block.

The image decoding apparatus 200 may calculate a BVG LM parameter (S2055). The image decoding apparatus 200 may calculate the BVG LM parameter using the correlation between a luma reference block indicated by one or many of the obtained BVs (or BV information) and a chroma reference block indicated by the corresponding BV. Here, the BVG LM parameter may be a relational expression calculated using the correlation between a luma reference block and a chroma reference block. A method of calculating a BVG LM parameter may be identical to a method used in the CCLM, multi-model CCLM, and the like.

The image decoding apparatus 200 may apply a BVG CCLM (S2060). In other words, the image decoding apparatus 200 may apply the BVG LM parameter to the corresponding luma block. By applying the BVG LM parameter to the corresponding luma block, the image decoding apparatus 200 may generate a chroma prediction block.

When the BVGCCLM flag does not have a value of 1 (No in S2030), the image decoding apparatus 200 may calculate an LM parameter (S2070). Specifically, the image decoding apparatus 200 may calculate an LM parameter between the corresponding luma block and the current chroma block in the same manner as in the existing CCLM.

The image decoding apparatus 200 may apply the LM (S2075). In other words, the image decoding apparatus 200 may apply the calculated LM parameter to the corresponding luma filter. By applying the calculated LM parameter to the corresponding luma filter, the image decoding apparatus 200 may generate a chroma prediction block.

According to an embodiment of the present disclosure, the image encoding apparatus 100 and/or the image decoding apparatus 200 may generate a chroma prediction block by utilizing a current chroma block and BV information of a corresponding luma block or the current chroma block and BV information stored around the corresponding luma block. For example, when the corresponding luma block is coded in the intraTMP or IBV mode, BV information of the corresponding luma block may exist. Alternatively, when the corresponding luma block is coded in the intraTMP or IBV mode, multi-block vector information may exist at the corresponding position. When a final prediction block is generated by calculating a weighted sum of several reference blocks in the intraTMP mode, bi-predictive IBC is applied, or the IBC mode includes two or more reference blocks, multi-block vector information may exist. In this case, according to the present disclosure, a current chroma block can be effectively performed using the multi-block vector information. Here, the multiple pieces of BV information (multi-block vector information) may be obtained from the following positions.
A BV at position of C 1810
A BV at position of TL 1820
A BV at position of TR 1830
A BV at position of BL 1840
A BV at position of BR 1850

Multiple pieces of BV information may be stored at each position, and the stored BV information may be included in a candidate list as candidate BVs. When a BV candidate list is generated, BVs existing at all the foregoing positions may be included as candidates, or only some of the BVs may be included as candidates.

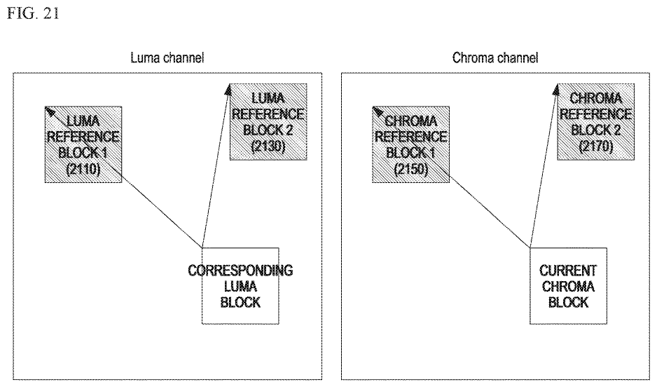

FIG. 21 is a diagram showing reference blocks when multiple BVs exist according to an embodiment of the present disclosure. Referring to FIG. 21, the image encoding apparatus 100 and/or the image decoding apparatus 200 may generate/apply multiple models for/to multiple pieces of BV information using the correlation between luma reference blocks 2110 and 2130 at positions indicated by BVs and chroma reference blocks 2150 and 2170 indicated by the BVs. Specifically, the image encoding apparatus 100 and/or the image decoding apparatus 200 may obtain a relational expression using the correlation between the luma reference block 1 (2110) and the chroma reference block 1 (2150). Also, the image encoding apparatus 100 and/or the image decoding apparatus 200 may obtain a relational expression using the correlation between the luma reference block 2 (2130) and the chroma reference block 2 (2170). In this case, multiple models may be generated. In other words, two relational expressions may be generated. During a chroma prediction block generation operation, one of the two models (relational expressions) may be signaled and applied. Accordingly, one chroma prediction block may be generated.

Alternatively, the image encoding apparatus 100 and/or the image decoding apparatus 200 may generate two chroma prediction blocks by applying both the models (relational expressions) and then generate a final prediction block by calculating a weight sum of the two chroma prediction blocks. In this case, a weight applied to each prediction block may be 0.5. Alternatively, a weight used in the luma block may be inherited and used in the chroma block. For example, when the corresponding luma block is coded using an intraTMP fusion mode, a weighted sum of multiple reference blocks may be calculated to predict a luma block. In other words, a final luma prediction block may be generated by calculating a weighted sum of multiple luma prediction blocks. Accordingly, in the case of utilizing a BV of the corresponding luma block at a current chroma block, weights used in generating a final luma block to generate a final chroma prediction block may be applied to multiple chroma blocks without any change.

In the case of obtaining a relational expression using the correlation between a luma reference block and a chroma reference block, the luma reference block may be scaled (i.e., down-sampled) in accordance with the chroma reference block. The above-described embodiments are applicable to the CCLM, the above CCLM for deriving/applying above reconstructed neighboring samples, the left CCLM for deriving/applying left reconstructed neighboring samples, the multi-model CCLM for deriving/applying multiple models, the GLM, the CCCM, the multi-model CCCM for deriving/applying multiple models, the above CCCM for deriving/applying above reconstructed neighboring samples, the left CCLM for deriving/applying left reconstructed neighboring samples, the GL-CCCM, and the non-down-sampled CCCM.

The number of pieces of BV information according to the present disclosure may be K. In the present disclosure, only P of the K pieces of BV information may be used. Here, K and P may be natural numbers, and P may be a natural number less than or equal to K.

Also, a weight sum of the generated chroma prediction block and a prediction block generated using non-CCLM and/or non-CCCM intra chroma modes may be calculated. For example, a weight sum of the chroma prediction block generated according to the present disclosure and a prediction block generated using one of the DM mode, the DIMD mode, and the four default modes (planar, vertical, horizontal, and DC modes) may be calculated. Whether to calculate a weighted sum may be known through signaling or by an agreement between the image encoding apparatus 100 and the image decoding apparatus 200.

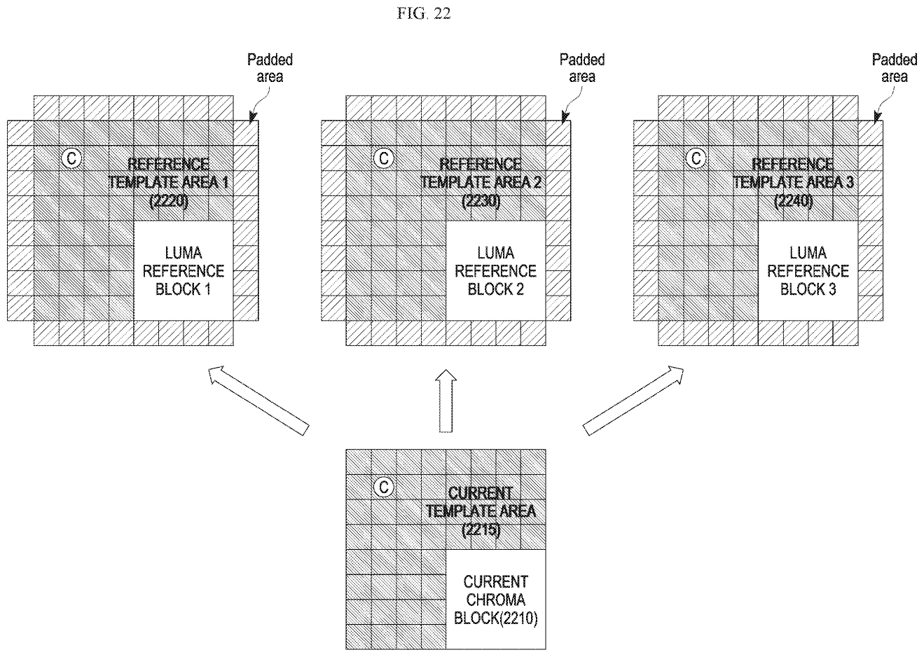

FIG. 22 is a diagram showing multiple luma reference blocks and a current chroma block according to an embodiment of the present disclosure. According to the present disclosure, filter coefficients may be derived using the correlation between multiple luma reference blocks indicated by BVs in connection with multiple pieces of BV information and a current chroma block. In this way, the image encoding apparatus 100 and/or the image decoding apparatus 200 can predict the current chroma block using the multiple luma reference blocks. For example, the image encoding apparatus 100 and/or the image decoding apparatus 200 may train filter coefficients such that the MSE between a current chroma template area 2215 of a current chroma block 2210 and multiple reference template areas 2220, 2230, and 2240 is minimized. As shown in equation 12 below, the image encoding apparatus 100 and/or the image decoding apparatus 200 may generate a chroma prediction block by utilizing the trained filter coefficients.

$${Output}_{i} = {c}_{0} {S}_{1} + {c}_{1} {S}_{2} + … + {c}_{n - 1} {S}_{n - 1} + {c}_{n} B \qquad [ Equation 12 ]$$

Outputᵢ: the i^{th} sample (predicted sample value) of a current chroma block.
C₀, C₁, . . . , Cₙ₋₁, and Cₙ: filter coefficients
S₁: a luma sample at a position corresponding to outputᵢ in luma reference block 1.
S₁: a luma sample at a position corresponding to outputᵢ in luma reference block 2.
S₃: a luma sample at a position corresponding to outputᵢ in luma reference block 3.
Sₙ₋₁: a luma sample at a position corresponding to outputᵢ in luma reference block n−1.
B: a bias term, which may have a value of, for example, (1<<(bit depth−1)).

Whether to apply a filter according to the present disclosure may be signaled using a flag or determined by an agreement between the image encoding apparatus 100 and/or the image decoding apparatus 200. Also, how many luma reference blocks will be fused together may be signaled as index information, etc., or determined by an agreement between the image encoding apparatus 100 and/or the image decoding apparatus 200.

The current chroma block and the corresponding luma block may also be included as candidate luma reference blocks. In addition, a weighted sum of the generated chroma prediction block and prediction blocks generated using non-CCLM and/or non-CCCM intra chroma modes may be calculated. For example, a weighted sum of the chroma prediction block generated according to the present embodiment and prediction blocks generated using the DM, the DIMD, or the four the four default modes (planar, vertical, horizontal, and DC modes). Whether to calculate a weighted sum may be signaled or determined by an agreement between the image encoding apparatus 100 and/or the image decoding apparatus 200.

### Embodiment 2

Embodiment 2 proposes a signaling method of embodiments according to the present disclosure According to the embodiment of the present disclosure, information to be applied to the present embodiment may be signaled as shown in table 5 to table 13 below.

TABLE 5

| Coding unit syntax | Descriptor |
|---|---|
| ... | |
| modeIdx | ac(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ae(v) |
| if( hasChromaBvCheck ) { | |
| bvgChromaFlag | ae(v) |
| } | |
| } | |
| } | |
| ... | |
| isChromaFusion | ae(v) |
| ... | |

TABLE 6

| Coding unit syntax | Descriptor |
|---|---|
| ... | |
| modeIdx | ae(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ae(v) |
| } | |
| if( hasChromaBvCheck ) { | |
| bvgChromaFlag | ae(v) |
| } | |
| } | |
| ... | |
| isChromaFusion | ae(v) |
| ... | |

TABLE 7

| Coding unit syntax | Descriptor |
|---|---|
| ... | |
| modeIdx | ae(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ac(v) |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| } | |
| } | |
| ... | |
| isChromaFusion | ae(v) |
| ... | |

TABLE 8

| Coding unit syntax | Descriptor |
|---|---|
| ... | |
| modeIdx | ae(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ae(v) |
| } | |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| } | |
| ... | |
| isChromaFusion | ae(v) |
| ... | |

TABLE 9

| Coding unit syntax | Descriptor |
|---|---|
| ... | |
| modeIdx | ae(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ae(v) |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| } | |
| } | |
| ... | |
| if( ! MultiBvfusionFlag) { | |
| isChromaFusion | ae(v) |
| } | |
| ... | |

TABLE 10

| Coding unit syntax | Descriptor |
|---|---|
| ... | |
| modeIdx | ae(v) |
| cccmFlag | ae(v) |
| if ( cccmFlag ) | |
| { | |
| cccmNoSubFlag | ae(v) |
| if( ! cccmNoSubFlag ) | |
| { | |
| glCccmFlag | ae(v) |
| } | |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| } | |
| ... | |
| if( ! MultiBvfusionFlag ) { | |
| isChromaFusion | ae(v) |
| } | |
| ... | |

TABLE 11

| Coding unit syntax | Descriptor |
|---|---|
| ... | |
| modeIdx | ac(v) |
| cccmFlag | ae(v) |
| if ( cccmFlag ) { | |
| ... | |
| } | |
| glmFlag | ae(v) |
| if ( glmFlag ) { | |
| ... | |
| } | |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| ... | |
| isChromaFusion | ae(v) |
| ... | |

TABLE 12

| Coding unit syntax | Descriptor |
|---|---|
| ... | |
| modeIdx | ae(v) |
| cccmFlag | ae(v) |
| if ( cccmFlag ) { | |
| ... | |
| } | |
| glmFlag | ae(v) |
| if ( glmFlag ) { | |
| ... | |
| } | |
| if( hasChromaBvCheck ) { | |
| bvgChromaFlag | ae(v) |
| if( bvgChromaFlag && multiBvCheck ) { | |
| MultiBvfusionFlag | ae(v) |
| } | |
| } | |
| ... | |
| if( ! MultiBvfusionFlag) { | |
| isChromaFusion | ae(v) |
| } | |
| ... | |

TABLE 13

| Coding unit syntax | Descriptor |
|---|---|
| ... | |
| modeIdx | ae(v) |
| cccmFlag | ae(v) |
| if ( cccmFlag ) { | |
| ... | |
| } | |
| glmFlag | ac(v) |
| if ( glmFlag ) { | |
| ... | |
| } | |
| if( hasChromaBvCheck ) { | |
| bvgChromaFlag | ae(v) |
| } | |
| ... | |
| isChromaFusion | ae(v) |
| ... | |

cccmflag existing in tables 5 to 13 may be a flag regarding whether to apply the CCCM. cccmNoSubFlag may be a flag indicating whether to apply the CCCM without subsampling. glCcemFlag may be a flag indicating whether to apply the GL-CCCM. hasChromaBvCheck may be a condition of checking whether a BV is stored in a luma block corresponding to a current chroma block or neighboring luma blocks of the luma block corresponding to the current chroma block. bvgChromaFlag may be a flag indicating whether to apply the CCCM by obtaining a relational expression between a luma reference block indicated by a BV and a chroma reference block indicated by the BV. multiBvCheck may be a condition of checking whether multiple BVs are stored in the luma block corresponding to the current chroma block or the neighboring luma blocks corresponding to the current chroma block.

isChromaFusion may be information about whether to perform fusion. isChromaFusion may be information indicating whether a model that is weighted and summed up with a prediction block generated using a mode, for example, the DM, the DIMD, the four default modes (planar, vertical, horizontal, and DC modes), or the like is a single model or multiple models.

modeIdx may be index information indicating which model will be applied among a CCCM, the multi-CCCM, the above CCCM, the left CCCM, and the like. Here, the above CCCM is a CCCM mode in which above reconstructed neighboring samples are used for deriving a filter coefficient. The left CCCM is a CCCM mode in which left reconstructed neighboring samples are used for deriving a filter coefficient. Alternatively, according to another embodiment of the present disclosure, modeIdx may be index information indicating which model will be applied among a single model, multiple models, a left shape single model, an above shape single model, left shape multiple models, and above shape multiple models. Here, a left shape model is a model that derives a filter coefficient using only an adjacent left shape template area of a reference block. An above shape model is a model that derives a filter coefficient using only an adjacent above shape template area of a reference block.

multiBvfusionFlag may be information about whether to generate a chroma prediction block by calculating a weighted sum of luma prediction blocks generated based on multiple luma reference block vectors. glmFlag may be a flag indicating whether to apply the GL-CCCM.

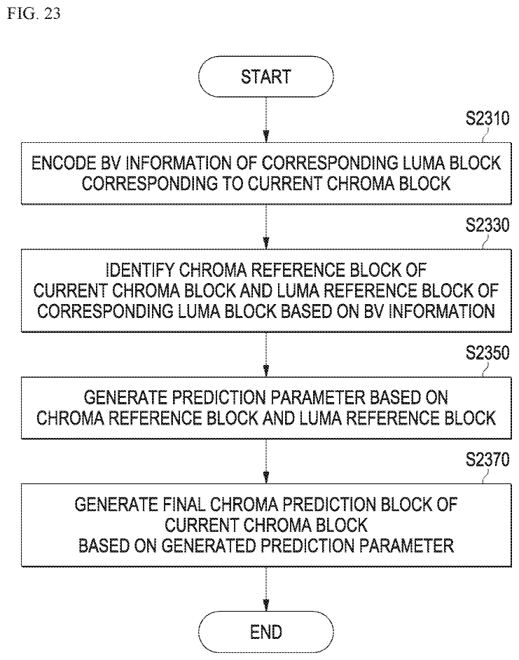

FIG. 23 is a flowchart of an image encoding method according to an embodiment of the present disclosure. Referring to FIG. 23, the image encoding apparatus 100 may encode BV information of a corresponding luma block corresponding to a current chroma block (S2310). The image encoding apparatus 100 may identify a chroma reference block of the current chroma block and a luma reference block of the corresponding luma block based on the BV information (S2330). The image encoding apparatus 100 may generate a prediction parameter based on the chroma reference block and the luma reference block (S2350). The image encoding apparatus 100 may generate a final chroma prediction block of the current chroma block based on the generated prediction parameter (S2370).

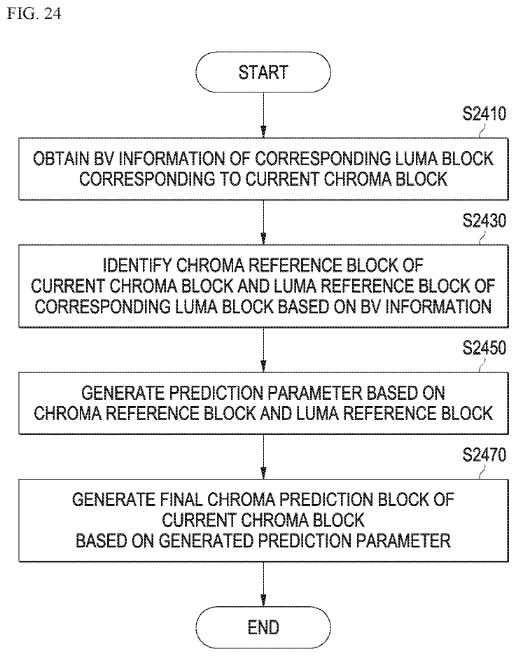

FIG. 24 is a flowchart of an image decoding method according to an embodiment of the present disclosure. Referring to FIG. 24, the image decoding apparatus 200 may obtain BV information of a corresponding luma block corresponding to a current chroma block (S2410). The image decoding apparatus 200 may identify a chroma reference block of the current chroma block and a luma reference block of the corresponding luma block based on the BV information (S2430). The image decoding apparatus 200 may generate a prediction parameter based on the chroma reference block and the luma reference block (S2450). The image decoding apparatus 200 may generate a final chroma prediction block of the current chroma block based on the generated prediction parameter (S2470).

According to an embodiment of the present disclosure, when there are a plurality of corresponding luma blocks, BV information may include BV information of predetermined positions in the plurality of corresponding luma blocks. Here, the plurality of corresponding luma blocks may include a top-left corresponding luma block, a top-right corresponding luma block, a bottom-left corresponding luma block, a bottom-right corresponding luma block, and a central corresponding luma block. Also, the predetermined positions may include at least one of a top-left luma sample position in the top-left corresponding luma block, a top-right luma sample position in the top-right corresponding luma block, a bottom-left luma sample position in the bottom-left corresponding luma block, a bottom-right luma sample position in the bottom-right corresponding luma block, and a top-left luma sample position in the central corresponding luma block, A top-left luma sample in the top-left corresponding luma block, a top-right luma sample in the top-right corresponding luma block, a bottom-left luma sample in the bottom-left corresponding luma block, a bottom-right luma sample in the bottom-right corresponding luma block, and a top-left luma sample in the central corresponding luma block may be TL 1820, TR 1830, BL 1840, BR 1850, and C 1810 shown in FIG. 18, respectively.

According to an embodiment of the present disclosure, when there are N pieces of BV information of the predetermined positions, the image encoding apparatus 100 and/or the image decoding apparatus 200 may generate a BV candidate list. N may be a natural number. In other words, the image encoding apparatus 100 and/or the image decoding apparatus 200 may generate a BV candidate list including N pieces of BV information. In this case, the image encoding apparatus 100 may encode a first BV index indicating first BV information included in the BV candidate list. Alternatively, the image decoding apparatus 200 may obtain the first BV index indicating the first BV information included in the BV candidate list. The image encoding apparatus 100 and/or the image decoding apparatus 200 may generate a final chroma prediction block based on the encoded or obtained index.

According to an embodiment of the present disclosure, when there are N pieces of BV information of predetermined positions, the image encoding apparatus 100 and/or the image decoding apparatus 200 may generate a BV candidate list. N may be a natural number. In this case, the image encoding apparatus 100 may encode a second BV index indicating second BV information included in the BV candidate list and a third BV index indicating third BV information. Alternatively, the image decoding apparatus 200 may obtain the second BV index indicating the second BV information included in the BV candidate list and the third BV index indicating the third BV information. The image encoding apparatus 100 and/or the image decoding apparatus 200 may generate a first chroma prediction block based on the second BV index and generate a second chroma prediction block based on the third BV index. The image encoding apparatus 100 and/or the image decoding apparatus 200 may generate a final chroma prediction block by calculating a weighted sum of the first chroma prediction block and the second chroma prediction block.

Here, the BV information of the predetermined positions for generating the BV candidate list may be searched for in a predetermined order. For example, to generate the BV candidate list, the image encoding apparatus 100 and/or the image decoding apparatus 200 may search for BV information in order of a top-left luma sample in a central corresponding luma block, a top-left luma sample in a top-left corresponding luma block, a top-right luma sample in a top-right corresponding luma block, a bottom-left luma sample in a bottom-left corresponding luma block, and a bottom-right luma sample in a bottom-right corresponding luma block. The present disclosure is not limited thereto, and BV information may be searched for in various orders.

According to an embodiment of the present disclosure, the image encoding apparatus 100 and/or the image decoding apparatus 200 may calculate a weighted sum of two chroma prediction blocks to generate a final chroma prediction block. Specifically, the image encoding apparatus 100 and/or the image decoding apparatus 200 may generate a chroma prediction block (e.g., a third chroma prediction block) based on an intra prediction mode. Also, the image encoding apparatus 100 and/or the image decoding apparatus 200 may generate a chroma prediction block (e.g., a fourth chroma prediction block) based on prediction parameters. The image encoding apparatus 100 and/or the image decoding apparatus 200 may generate a final prediction block by calculating a weighted sum of the chroma prediction block (e.g., the third chroma prediction block) based on an intra prediction mode and the chroma prediction block (e.g., the fourth chroma prediction block) based on the prediction parameters. Here, the intra prediction mode used for generating the third chroma prediction block may be one of the planar mode, the DC mode, and the directional modes. Also, the prediction parameters may be filter coefficients used in the CCCM or LM parameters used in the CCLM.

While exemplary methods of the present disclosure are represented as a series of operations for clarity of description, it is not intended to limit the order in which the steps are performed, and the steps may be performed simultaneously or in a different order as necessary. To implement a method according to the present disclosure, the illustrated steps may further include different or other steps, include remaining steps except for some of the steps, or include other additional steps except for some of the steps.

In the present disclosure, an image encoding apparatus or an image decoding apparatus performing a certain operation (step) may perform an operation (step) of checking execution conditions or circumstances of a corresponding operation (step). For example, when it is described that a certain operation is performed upon the satisfaction of a certain condition, the image encoding apparatus or the image decoding apparatus may perform an operation of checking whether the certain condition is satisfied and then perform the certain operation.

Various embodiments of the present disclosure do not disclose a list of all possible combinations and are intended to describe representative aspects of the present disclosure. Matters described in various embodiments may be applied independently or in combination of two or more.

In addition, various embodiments of the present disclosure may be implemented in hardware, firmware, software, or a combination thereof. In the case of hardware implementation, the present disclosure may be implemented by one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, and the like.

In addition, an image decoding apparatus and an image encoding apparatus to which an embodiment of the present disclosure is applied may be included in a multimedia broadcast transceiver, a mobile communication terminal, a home cinema video device, a digital cinema video device, a surveillance camera, a video chat device, a device for real-time communication such as video communication, a mobile streaming device, a storage medium, a camcorder, a video on demand (VOD) service provider, an over the top (OTT) video device, an Internet streaming service provider, a three-dimensional (3D) video device, a videotelephony video device, a medical video device, etc., and may be used for processing video signals or data signals. For example, the OTT video device may include a game console, a Blu-ray player, an Internet access television (TV), a home theater system, a smartphone, a tablet personal computer (PC), a digital video recorder (DVR), and the like.

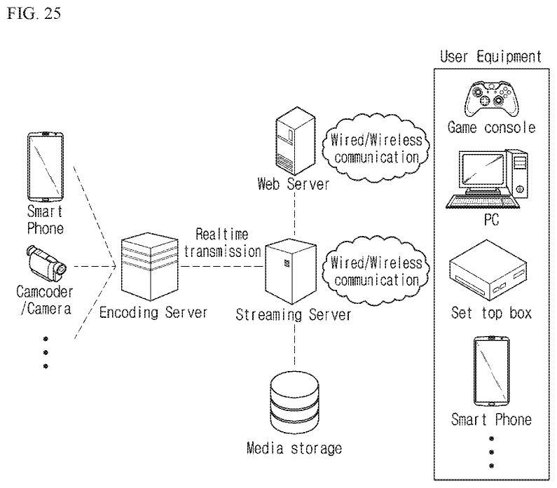

FIG. 25 is a view showing a content streaming system, to which an embodiment of the present disclosure is applicable.

As shown in FIG. 25, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
obtaining block vector (BV) information of a corresponding luma block corresponding to a current chroma block;
identifying a chroma reference block of the current chroma block and a luma reference block of the corresponding luma block based on the BV information;
generating a prediction parameter based on the chroma reference block and the luma reference block; and
generating a final chroma prediction block of the current chroma block based on the generated prediction parameter.

2. The image decoding method of claim 1, wherein, based on the corresponding luma block being plural in number, the BV information includes BV information of a predetermined position within the plurality of corresponding luma blocks.

3. The image decoding method of claim 2, wherein the plurality of corresponding luma blocks include a top-left corresponding luma block, a top-right corresponding luma block, a bottom-left corresponding luma block, a bottom-right corresponding luma block, and a central corresponding luma block, and
the predetermined position includes at least one of a top-left luma sample position in the top-left corresponding luma block, a top-right luma sample position in the top-right corresponding luma block, a bottom-left luma sample position in the bottom-left corresponding luma block, a bottom-right luma sample position in the bottom-right corresponding luma block, and a top-left luma sample position in the central corresponding luma block.

4. The image decoding method of claim 2, further comprising:
generating a BV candidate list based on the BV information of the predetermined position being N pieces in number; and
obtaining a first BV index indicating first BV information included in the BV candidate list,
wherein the final chroma prediction block is generated based on the first BV index, and
N is a natural number.

5. The image decoding method of claim 2, further comprising:
generating a BV candidate list based on the BV information of the predetermined position being N pieces in number;
obtaining a second BV index indicating second BV information included in the BV candidate list; and
obtaining a third BV index indicating third BV information included in the BV candidate list,
wherein the final chroma prediction block is generated by calculating a weighted sum of a first chroma prediction block which is generated based on the second BV index and a second chroma prediction block which is generated based on the third BV index, and
N is a natural number.

6. The image decoding method of claim 5, wherein the BV information of the predetermined position for generating the BV candidate list is searched for in a predetermined order.

7. The image decoding method of claim 1, wherein the generating of the prediction parameter further comprises down-sampling the luma reference block based on a size of the chroma reference block.

8. The image decoding method of claim 1, wherein the generating of the final chroma prediction block comprises:
generating a third chroma prediction block based on an intra prediction mode;
generating a fourth chroma prediction block based on the prediction parameter; and
generating a final chroma prediction block by calculating a weighted sum of the third chroma prediction block and the fourth chroma prediction block.

9. The image decoding method of claim 8, wherein the intra prediction mode is one of a planar mode, a direct current (DC) mode, and directional modes.

10. The image decoding method of claim 1, wherein the prediction parameter is one of a filer coefficient used in a convolutional cross-component intra prediction model (CCCM) and a linear model parameter used in a cross-component linear model (CCLM).

11. The image decoding method of claim 1, wherein the BV information of the corresponding luma block includes BV information of neighboring blocks of the corresponding luma block.

12. An image encoding method performed by an image encoding apparatus, the image encoding method comprising:
encoding block vector (BV) information of a corresponding luma block corresponding to a current chroma block;
identifying a chroma reference block of the current chroma block and a luma reference block of the corresponding luma block based on the BV information;
generating a prediction parameter based on the chroma reference block and the luma reference block; and
generating a final chroma prediction block of the current chroma block based on the generated prediction parameter.

13. A computer-readable recording medium for storing a bitstream generated using the image encoding method of claim 12.

14. A method of transmitting a bitstream generated using an image encoding method, wherein the image encoding method comprises:
encoding block vector (BV) information of a corresponding luma block corresponding to a current chroma block;
identifying a chroma reference block of the current chroma block and a luma reference block of the corresponding luma block based on the BV information;
generating a prediction parameter based on the chroma reference block and the luma reference block; and
generating a final chroma prediction block of the current chroma block based on the generated prediction parameter.
